(19) United States
(12) Patent Application Publication
(10) Pub. No.: US 2026/0273817 A1
(43) Pub. Date: Sep. 17, 2026

(54) METHOD FOR MANUFACTURING A HEAD HOUSING OF A HUMANOID ROBOT

(71) Applicant: Figure AI Inc., San Jose, CA (US)

(72) Inventors: Keyvan Yeganeh, San Jose, CA (US); Vadim Chernyak, San Jose, CA (US)

(21) Appl. No.: 19/565,133

(22) Filed: Mar. 12, 2026

Related U.S. Application Data
(60) Provisional application No. 63/770,620, filed on Mar. 12, 2025.

(51) Int. Cl. B29C 45/16; B25J 11/00; B29C 45/00; B29L 31/00

(52) U.S. Cl. CPC B29C 45/16; B25J 11/0065; B29C 45/0053; B29C 2045/0079; B29K 2995/0025; B29K 2995/0026; B29L 2031/748

(57) ABSTRACT

A method of manufacturing a head housing for a humanoid robot including: injecting a first material into a first cavity to form a shell of the head housing, the first cavity defining an exterior surface of the shell and surrounding a first core that defines an interior surface of the shell; after forming the shell, positioning the shell within a second cavity which has a different shape than the first cavity, defines an exterior surface of a shield of the head housing, and surrounds a second core partially defining the interior surface of the shield; and injecting a second material having a opacity lass then the first material into the second cavity to form the shield on the shell and the second core that partially defines the interior surface of the shield, the second material bonds with the exterior surface of the shell to form a unitary head housing structure.

### CROSS-REFERENCE TO RELATED APPLICATIONS

This application claims the benefit of and priority to U.S. Provisional Patent Application Nos. 63/770,620 filed Mar. 12, 2025, which is hereby expressly incorporated by reference herein in its entirety.

### TECHNICAL FIELD

This disclosure relates to a method of manufacturing a head of a robot, specifically to a method for manufacturing a head housing for a humanoid robot.

### BACKGROUND

Humanoid robots are increasingly being developed for a wide range of applications, from industrial automation to personal assistance. For a humanoid robot to function effectively and safely, particularly in environments shared with humans, it must be able to perceive its surroundings, navigate complex spaces, and communicate its status and intent. The head assembly of a humanoid robot is a central component, as it typically houses the primary sensor suites for perception, displays for human-robot interaction, and antennas for wireless communication. However, manufacturing a head for a functional, general-purpose humanoid robot presents significant challenges that are not addressed by conventional robotic systems. Existing manufacturing methods often suffer from several limitations. For instance, manufacturing a shell and shield separately can result in the shield not fitting the shell and take a long time to manufacture each of the shield and the shell. Accordingly, additional time and resources are expended to remedy this defect which results in additional costs and low efficiency during the manufacturing process. There is a need for a manufacturing method that allows for the shield to match the geometries of the shell without involving significant manipulation of the shell and shield after they are molded.

Durability is another major concern, especially for robots intended for industrial or commercial use. Designs that integrate displays and sensors into the exterior surface of a shield or shell without adequate protection are vulnerable to impact. Damage to these integrated components can be costly and time-consuming to repair, leading to significant operational downtime. An improved manufacturing method for a more robust and modular design is needed where critical components are protected and easily replaceable.

### SUMMARY

According to an aspect of the present disclosure, a method of manufacturing a head housing for a humanoid robot, includes: injecting a first material into a first cavity to form a shell of the head housing, the first cavity defines an exterior surface of the shell, the first cavity surrounds a first core that defines an interior surface of the shell, and the first material of the formed shell has a first opacity; after forming the shell, positioning the shell within a second cavity having a different shape than the first cavity, the second cavity defines an exterior surface of a shield of the head housing, and the second cavity surrounds a second core that partially defines the interior surface of the shield; and injecting a second material different from the first material into the second cavity to form the shield on the shell and the second core that partially defines the interior surface of the shield, the second material bonds with the exterior surface of the shell to form a unitary head housing structure, and the second material of the formed shield has a second opacity that is less than the first opacity.

The method may further include: before injecting the first material into the first cavity, moving a moving platen of an injection molding machine against a fixed platen of the injection molding machine, the moving platen may include the first cavity, and the fixed platen may include the first core that defines the interior surface of the shell; after injecting the first material into the first cavity: separating the moving platen from the fixed platen; replacing the first cavity with the second cavity; and moving the moving platen which may include the second cavity against the fixed platen; and after injecting the second material into the second cavity, separating the moving platen from the fixed platen to release the unitary head housing structure.

The first core that defines the interior surface of the shell and the second core that partially defines the interior surface of the shield may be separate portions of a single core, and the shell may remain on the single core while injecting the second material into the second cavity.

The first material may include a first polymer, and the second material may include a second polymer.

The shield may have a surface that is curved along both a z-axis of the head housing and an x-axis of the head housing.

The method may further include: forming a plurality of display housing sections; and after injecting the second material into the second cavity to form the shield on the shell, attaching the plurality of display housing sections to the shell such that the plurality of display housing sections are covered by the shield.

The injecting the second material different from the first material into the second cavity to form the shield on the shell and the second core that partially defines the interior surface of the shield may include embedding one or more functional elements within the shield, the one or more functional elements may include at least one of a transparent conductive film, a reinforcement grid, an antenna structure, or a microelectronic component.

The one or more functional elements may include a transparent conductive pathway that enables at least one of a touch-sensitive interface or a transparent antenna.

The method may further include: after injecting the second material into the second cavity to form the shield on the shell, moving the unitary head housing structure to a polishing station using a robotic arm; and polishing the shield at the polishing station using a polishing tool of the robotic arm.

The polishing the shield may include securing the unitary head housing structure in a fixture of the polishing station and manipulating the polishing tool across the exterior surface of the shield.

The method may further include :after polishing the shield, moving the unitary head housing structure from the polishing station to a coating station comprising a rotary stand; attaching the unitary head housing structure to the rotary stand; and while rotating the rotary stand, applying a coating via one or more sprayers to the exterior surface of the shield, the coating may include at least one of an anti-reflective coating or a scratch-resistant hard coating.

The injecting the second material into the second cavity to form the shield on the shell may include forming the shield on the shell such that all edges of the shell are positioned within the shield.

According to another aspect of the present disclosure, a method of manufacturing a head housing for a humanoid robot, includes: injection molding a shell of the head housing by injecting a first material into a first mold, the shell is formed on a first portion of a first core and includes at least one display opening and a first plurality of sensor openings; after the shell is formed on the first core, replacing the first mold with a second mold; and overmolding a shield onto the shell by injecting a second material different from the first material into the second mold, the shield is formed on (i) the shell and (ii) a second core to form a unitary head housing structure, the shield is configured to cover the at least one display opening, and the shield includes a second plurality of sensor openings that are aligned with the first plurality of sensor openings of the shell.

The first core and the second core may be separate portions of a single core that is mounted to a fixed platen of an injection mold machine, and the first mold and the second mold may be each mounted to a moving platen of the injection mold machine.

The first core may include a protrusion, and the injection molding the shell may include molding the shell around the protrusion to form the at least one display opening.

The injection molding the shell may include injecting the first material through one or more injection tubes attached to a moving platen of an injection mold machine, and the overmolding the shield may include injecting the second material through the one or more injection tubes attached to the moving platen.

The second material may be transparent or semi-transparent after molding, and the first material may be opaque after molding.

The shield may extend from a chin region of the head housing to a parietal region of the head housing and may wrap around lateral sides of the head housing to respective auricular regions.

The shield may be curved in both a vertical direction and a horizontal direction across the head housing.

The unitary head housing structure may not cover an occipital region of a head of the humanoid robot, and the method may further include attaching the unitary head housing structure to a support frame that may include the occipital region of the head of the humanoid robot.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a perspective view of a humanoid robot;

FIG. 2 is a first perspective view of the head and neck assembly of the robot of FIG. 1 showing a head and neck assembly having: (i) a neck portion and (ii) a head portion;

FIG. 3 is a left side view of the head and neck assembly of FIG. 2;

FIG. 4 is an exploded view of a head housing of FIGS. 2 and 3 including: (i) a shell, (ii) a shield, (iii) display housing sections, and (iv) a support frame;

FIG. 5 is a left side view of the shell of FIG. 4;

FIG. 6 is a left side view of the shield of FIG. 4;

FIG. 7 is a side view of the shield overlaying the shell of FIGS. 5 and 6;

FIG. 8 is a side view of a display housing section of FIG. 4;

FIG. 9 is perspective view of the support frame of FIG. 4;

FIG. 10 is a side view of the support frame of FIG. 9;

FIG. 11 is a side view of the head housing of FIG. 4 when the shell, the shield, the display housing sections, and the support frame are assembled to each other;

FIG. 12 illustrates a flowchart of a manufacturing process of the head housing of FIG. 4;

FIG. 13 illustrates a process of molding the shell of the head housing of the manufacturing process of FIG. 12;

FIG. 14 illustrates a process of overmolding the shield onto the shell of the manufacturing process of FIG. 12;

FIG. 15 illustrates the shield overmolded onto the shell of the manufacturing process of FIG. 12;

FIG. 16 illustrates the shield and shell being moved together to a polishing station of the manufacturing process of FIG. 12;

FIG. 17 illustrates a polishing process for polishing the shield of the manufacturing process of FIG. 12;

FIG. 18 illustrates the shield and shell being moved together to a coating station of the manufacturing process of FIG. 12; and

FIG. 19 illustrates a coating process for coating the shield of the manufacturing process of FIG. 12.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to "one embodiment," "an embodiment," "an illustrative embodiment," etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of "at least one A, B, and C" can mean (A); (B); (C); (A and B); (A and C); (B and C); or (A, B, and C). Similarly, items listed in the form of "at least one of A, B, or C" can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. Introduction

The disclosed humanoid robot 1 includes a head and neck assembly coupled to a torso and having an overall shape that generally resembles a human head. The head and neck assembly includes a head portion that does not include large flat surfaces (e.g., opposed sides of a head 10.1, or is not in the shape of: (a) cube, (b) hexagonal prism, or (c) pentagonal prism). Instead, almost all the surfaces of the head are curvilinear or have substantial curvilinear aspects or segments. While the overall head shape is designed to resemble a human head 10.1, the disclosed head lacks pronounced human facial structures (cheeks, eye peripheral protrusions, a mouth, or other moving structures). The absence of such facial structures contributes to a non-humanlike appearance while still permitting the head to function as a housing for sensors, displays, and communication components.

The frontal and crown regions of the head are covered by a large freeform shell and shield wherein the curvature of the shell varies horizontally and laterally across the head. The freeform nature, size, and construction of the head allow the shield and shell to be formed as separate and distinct pieces from the displays that are positioned behind the shield and attached to the shell. The shield is overmolded onto the shell to provide an efficient manufacturing process such that additional time and resources are not needed to manipulate the shield in order to properly fit on the shell. Accordingly, this manufacturing process eliminates adhesives, ultrasonic welding, mechanical fasteners, and manual assembly by yielding a unitary head housing structure that is stronger, lighter, and vastly more functional than multi-piece assemblies. The resulting unitary head housing structure, in which the shell material and the shield material are bonded together during the molding cycle, exhibits enhanced structural integrity and dimensional precision compared to structures formed by joining discrete parts in post-production.

The positional relationship between the shield and the shell may allow the shield to protect the display and electronics contained in the shell from damage, which provides a substantial benefit over conventional manufacturing methods for manufacturing robot heads that lack this feature. For example, certain tasks (e.g., moving and cutting sheet metal) that the robot may perform on the factory floor may damage or break a display that is not protected behind a shield. Additionally, a damaged shield may be cheaper and easier to replace than a damaged shell and/or display. The shield: (i) extends rearward of the auricular region, and into the occipital region, (ii) extends to the chin region, and (iii) does not extend below a jaw line. In other words, the shield does not stop short of the auricular region and does not contain an outer perimeter that contains multiple recesses designed to receive an extent of the electronics assembly (e.g., light emitters).

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head 10.1, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

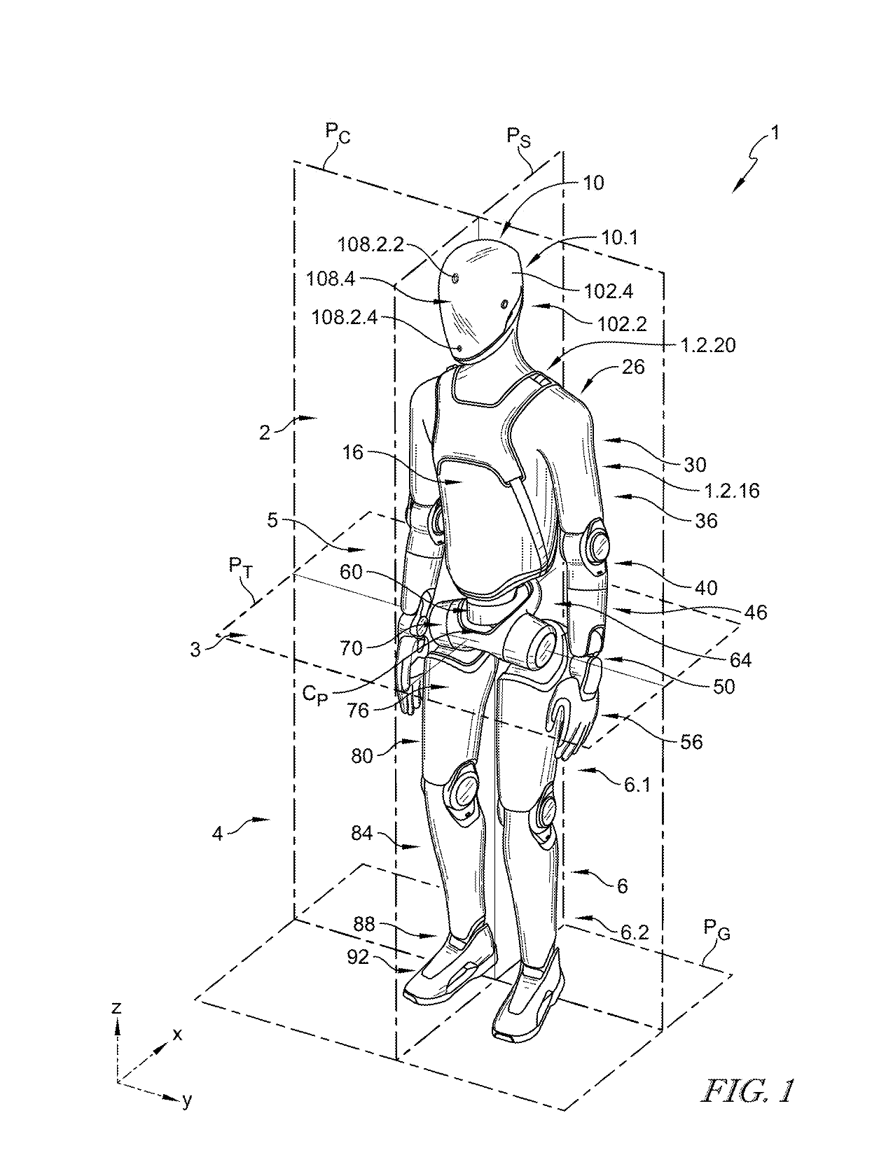

Neutral State: a state where the robot is standing upright on a horizontal support surface (P_{G}) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 1.

Extended State: a state of the robot with the arms extended outward laterally at the shoulder and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 1) is a vertical plane positioned at a midway point between the left and right legs and the left and right arms and contains a rotational axis A₁₀ of a torso twist actuator located in the spine 60 of the robot 1 and divides the left and right sides of the robot 1 (e.g., as illustrated in FIG. 1). In other words, in an illustrative embodiment, the sagittal plane (P_{S}) is a plane that is colinear with the rotational axis A₁₀ of the torso twist actuator.

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIG. 1), the coronal plane (P_{C}) is a vertical plane that contains the rotational axes of the hip flex actuators located in the hips 70 (and likewise may contain an axis defined by a line connecting the midpoints of a left hip flex actuator axis and a right hip flex actuator axis and rotational axis A₁₀ of torso twist actuator located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes of the hip flex actuators located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 1, an origin point (C_{P}) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 1 illustrates example Z, Y, X reference axes where the sagittal, coronal, and transverse planes share a common origin point.

Kinematic Chain: a representation of an assembly of rigid bodies connected by joints to provide constrained motion. Within this application, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth),engineered textiles, and non-fabric-like materials (e.g., plastics or polymers), and/or a combination of the above.

### C. Humanoid Robot

The humanoid robot 1 includes a variety of architectures and other components that may include: (i) a mechanical/electrical architecture that includes housings, actuators, an electronic assembly, sensors, a communication interface, an illumination assembly, data storage, an exterior covering assembly 1.2.16, external components 1.2.20, other components, and (ii) a compute module that includes a computing architecture.

### a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are often insufficient, and in some instances woefully insufficient, because they amount to mere design exercises that are not tethered to the complex realities of successfully creating a functional, general-purpose humanoid robot.

### i. Robot Components

In addition to the general systems, assemblies, components, and parts described above, the humanoid robot 1 in the illustrative embodiment shown in FIG. 1 may include the following systems, assemblies, components, and parts, which can be broadly categorized into three regions. As shown in FIG. 1, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 1, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head portion 10.1 is characterized by an absence of large flat surfaces (e.g., the head portion 10.1 is not a cube or prism) and the head is also not formed with significant cylindrical features or perfect circles. Instead, almost all exterior surfaces of the head portion 10.1 are curvilinear or contain substantial curvilinear aspects, which presents a generally egg-shaped appearance when viewed from the front or top.

Structurally, the head portion 10.1 is symmetrical about the sagittal plane P_{S} but is asymmetrical about the Z-Y and X-Y planes that intersect the head and are parallel to the coronal plane (P_{C}) and the transverse plane (P_{T}), respectively. The width (parallel to the y-axis) and depth (parallel to the x-axis) of the head portion 10.1 change constantly from top to bottom, reaching a maximum dimension in the temple region, which is located at approximately 30-50% of the head's height from its top end. This varying geometry influences the shape of both the shell and the shield that form the head housing, as each must conform to the changing cross-sectional profile of the head portion 10.1. The asymmetric dimensional characteristics of the head portion 10.1 also inform the design of the core and mold cavities used during the injection molding and overmolding manufacturing processes described herein.

The head portion 10.1 itself may house a range of components, such as high-resolution cameras, microphones, and displays, all of which are contained within an impact-resistant polymer housing 102. This housing 102 includes a large, freeform (i.e., not conforming to a regular or formal structure or shape) shield 102.4 that covers the frontal and crown regions of the head portion 10.1. The term freeform signifies that the shield does not conform to a regular or formal geometric structure or shape. The shield 102.4 is formed as a separate and distinct piece from the displays positioned behind it, thereby protecting the displays and internal electronics from damage. This separation provides a significant advantage during the performance of industrial tasks, as a damaged shield 102.4 is substantially cheaper and easier to replace than a damaged display. The shield 102.4 extends rearward beyond an auricular region into an occipital region and extends down to a chin region, but it does not extend below a jaw line. Because the shield 102.4 is overmolded onto the shell 102.2 as part of the manufacturing process, the shield 102.4 conforms to the exterior surface of the shell 102.2 with a high degree of precision, resulting in a unitary head housing structure that does not depend on adhesives, mechanical fasteners, or post-production welding.

Cameras that may be embedded within the head portion 10.1 may include RGB, depth-sensing, thermal imaging capabilities, and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. Microphones may be arranged in an array to facilitate directional audio input and noise cancellation, which enhances the ability of the humanoid robot 1 to understand and respond to verbal commands. Displays integrated into the head portion 10.1 may serve as user interfaces, providing visual feedback or conveying expressions to improve communication and user engagement. Further, an extent of an illumination assembly, which comprises a plurality of light emitters 108.12, is positioned adjacent to an edge (e.g.,lower) of the shield 102.4. These light emitters 108.12 may be configured to function as indicator lights to communicate the status of the robot 1 to nearby humans.

Additionally, the head portion 10.1 may house: (i) other sensors, such as gyroscopes and accelerometers, (ii) heat management systems (e.g.,heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck portion 10.2 to the antennas in the head portion 10.1. The head and neck assembly 10 may also incorporate advanced materials and shock-absorbing structures to protect the sensitive electronic components housed within, which may improve the overall durability and reliability of the humanoid robot 1. In some embodiments, the antennas may be embedded within or mounted to the shell 102.2, and the transparent or semi-transparent nature of the shield 102.4 may allow radio-frequency signals to pass through the shield 102.4 without substantial attenuation.

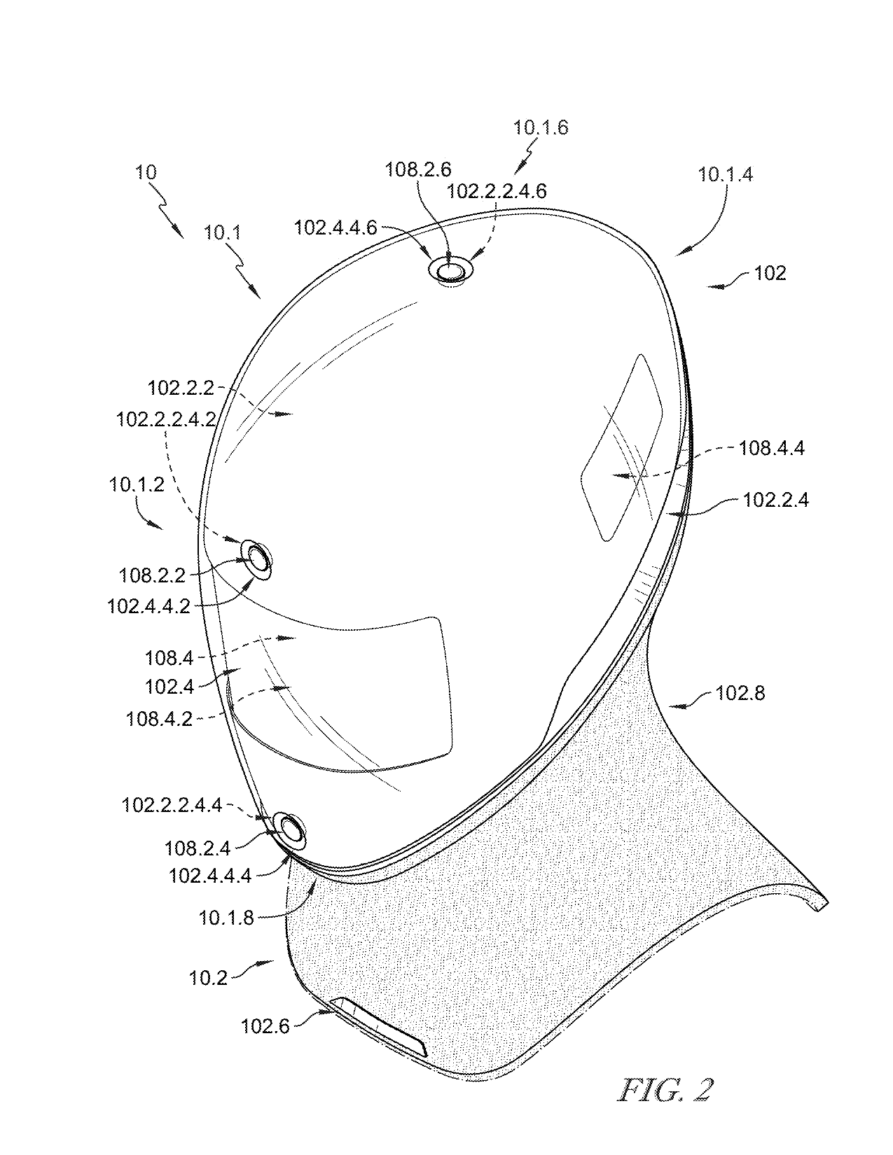

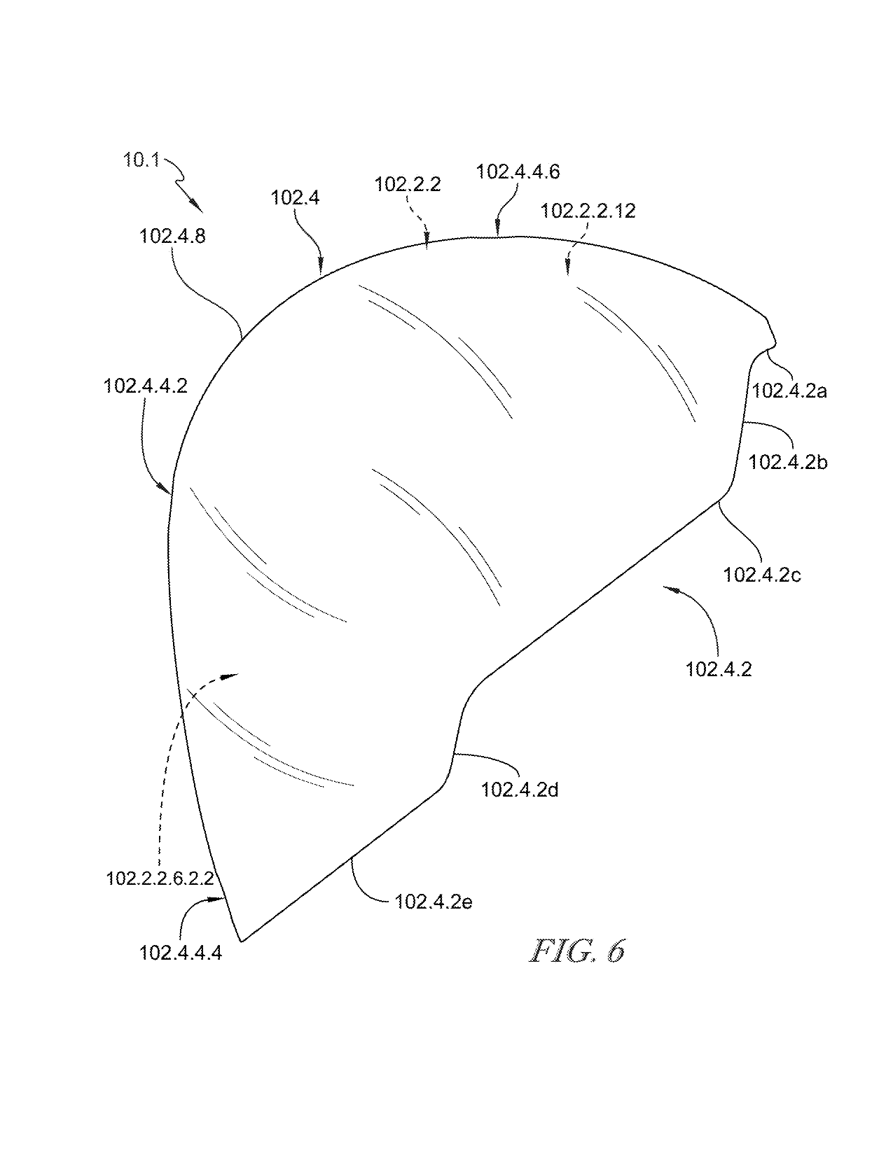

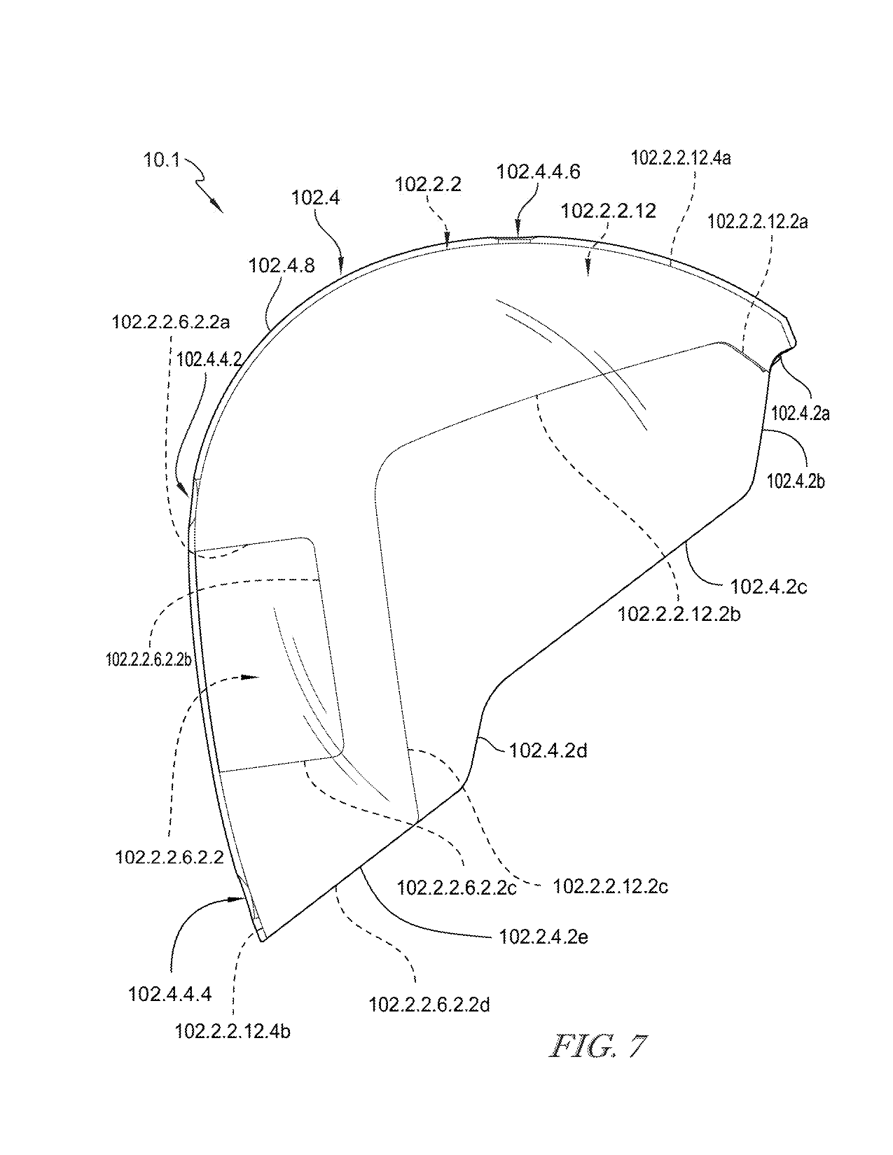

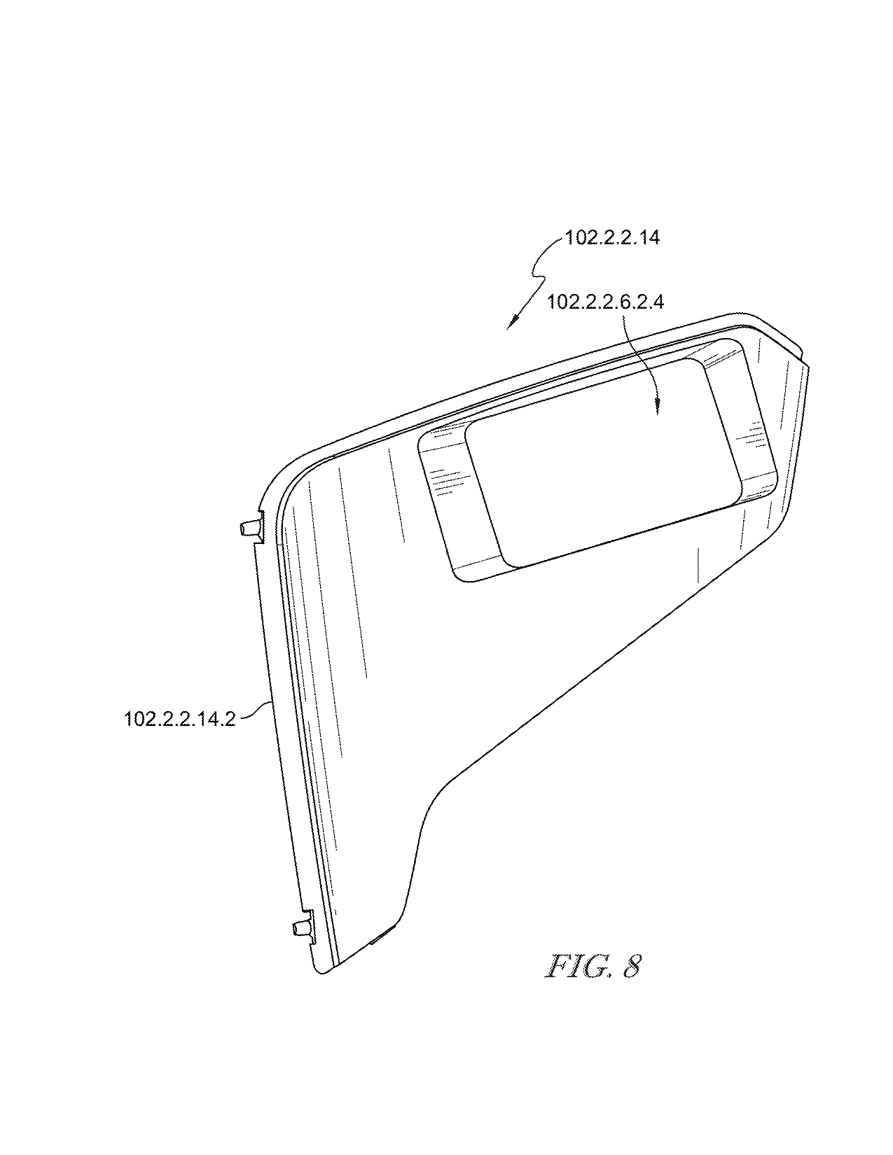

As shown in FIGS. 2-11, the head and neck assembly 10 of the humanoid robot 1 includes: (i) a head portion 10.1, and (ii) a neck portion 10.2. The head portion 10.1 and neck portion 10.2 are shaped to resemble the general shape of a human head and neck. The head portion 10.1 and the neck portion 10.2 are also configured to house and protect one or more actuators which cause the head to twist about an axis and nod about another axis. In some embodiments, the one or more actuators may enable the head portion 10.1 to rotate about a vertical axis and to tilt about a horizontal axis, thereby providing the humanoid robot 1 with a range of motion that emulates human head movement.

### a. Head Portion

The head portion 10.1 of the robot 1 has an exterior surface that provides said head portion 10.1 with an overall shape that is similar to the shape of a human head. In some embodiments, the head portion 10.1 is formed with no, or minimal, flat surfaces and is generally egg-shaped when viewed from the front and/or the top. The head portion 10.1 of the robot 1 changes constantly in width from top to bottom, wherein the width of the head portion 10.1 increases from a top or scalp end to a temple region where the head is widest. The temple region generally corresponds to an eye level of a human, or is at a location that is about 30-50% of a height of the head portion 10.1 from the top end. The width of the head portion 10.1 then decreases from the temple region to a lower or chin region. In this way, the head portion 10.1 of the robot 1 is asymmetrical about a first plane passing through a center or centroid C of the head portion 10.1 equidistant from the top end and the lower end. The head portion 10.1 of the robot is symmetrical about a second plane perpendicular to the first plane and passing through the center or centroid C of the head portion 10.1. In other embodiments, the head may be symmetrical about a first plane and asymmetrical about a second plane.

As shown in FIGS. 2-11, the head portion 10.1 of the head and neck assembly 10 includes: (i) a housing 102, (ii) an internal support assembly, and (iii) an electronics assembly 108. The housing 102 defines the overall shape of the head portion 10.1. The housing 102 is configured to contain and protect the internal support assembly and the electronics assembly 108. The internal support assembly is designed to securely mount and position the electronics assembly 108 within the head portion 10.1 of the robot 1. In the disclosed embodiments, the housing 102 is formed through an overmolding process in which the shield 102.4 is molded onto the shell 102.2 to yield a unitary head housing structure, as described in further detail below.

### i. Head Housing

As shown in FIGS. 2-11, the housing 102 is configured to have a form resembling the general shape of a human head. The housing 102 includes: (i) a shell 102.2, (ii) the shield 102.4, also referred to as skull, visor, or display covering, and (iii) a support frame 102.2.4, also referred to as a jaw member or rear/lower support frame, as shown in FIGS. 2-11. In other embodiments, the head housing 102 may have more components assembled together to contain and protect the components within the head portion 10.1. For example, the housing 102 may be made from more than two components (e.g., between 2 and 100). The modular design allows for individual components to be replaced without replacement of the entire housing 102. The housing 102 may be manufactured using processes such as injection molding or 3D printing and may include any known polymer material or other material. Examples include urethanes, PMMA, ABS, nylons, polyamides, polycarbonate (PC), polypropylene (PP), high-density polyethylene (HDPE), polystyrene (PS), polyvinyl chloride (PVC), thermoplastic elastomers (TPE), polyethylene terephthalate (PET), polybutylene terephthalate (PBT), polyoxymethylene (POM or acetal), epoxy resins, silicone rubber, polyimides (PI), acrylics, polyethylene (PE), liquid crystal polymers (LCP), phenolic resins, glass-filled nylons, carbon fiber reinforced plastics (CFRP), glass fiber reinforced plastics (GFRP), thermoplastic polyurethane (TPU), metal-plastic hybrids, biodegradable plastics (e.g., PLA), conductive polymers (e.g., PANI), any combination thereof, or any other similar material. The method of manufacturing the housing 102, including the overmolding of the shield 102.4 onto the shell 102.2 to form a unitary head housing structure, is discussed in further detail below.

As shown in FIGS. 2-11, a depth of the head of the robot 1 is defined by a combination of both the shield 102.4 and the support frame 102.2.4. The depth includes a maximum depth at a location that is about equal to the temple region and that extends between a front or facial region of the head portion 10.1 to an occipital region of the head portion 10.1. A front end 10.1.2 is provided by the shield 102.4 and a rear end 10.1.4 is provided by the support frame 102.2.4. The depth of the head portion 10.1 changes constantly from a top end 10.1.6 to a lower end 10.1.8. The depth increases from the top end 10.1.6 to the maximum depth and then decreases from the maximum depth to the lower end 10.1.8.

The head portion 10.1 of the robot 1 is symmetrical about the sagittal plane (P_{S}) but is asymmetrical about Z-Y and X-Y planes that (i) extend through the center or centroid C of the head portion 10.1, (ii) intersect the head portion 10.1, and (iii) are parallel to the coronal plane (P_{C}) and the transverse plane (P_{T}), respectively. The center C is spaced at equal distances from: (i) the top end 10.1.6 and the bottom end 10.1.8, (ii) the front end 10.1.2 and the rear end 10.1.4, and (iii) the lateral or left/right sides of the head portion 10.1. In other embodiments, the head portion 10.1 may be symmetrical about: (i) all planes, (ii) three of the planes, (iii) two of the planes, (iv) one of the planes, or (v) none of the planes. The symmetry or asymmetry of the head portion 10.1 about each plane influences the curvature profile of the shield 102.4, which in turn affects the design of the mold cavities and the core used in the manufacturing process.

### 1. Shell

The shell 102.2 includes: (i) an electronics mount or frame 102.2.2, (ii) a PCB mounting member, and (iii) an actuator mounting member. In other embodiments, the PCB mounting member and the actuator mounting member may be formed as one integrated component. Alternatively, said PCB mounting member and the actuator mounting member may be integrally formed with the support frame 102.2.4. The shell 102.2 serves as the substrate onto which the shield 102.4 is overmolded during the manufacturing process, such that the exterior surface of the shell 102.2 bonds with the shield material to form a unitary head housing structure.

The electronics mount 102.2.2 is configured to cover, surround, or overlie a majority of the electronics assembly 108. As shown in FIGS. 2-5, the electronics mount 102.2.2 extends: (i) from a crown region of the head portion 10.1 to the chin region, (ii) into the auricular region, (iii) into the occipital region, and (iv) into the lower extent of the parietal region. Like the shield 102.4, the electronics mount 102.2.2 is shaped with a curved surface to resemble a human head. In fact, the shape, radii, and curvature associated with the electronics mount 102.2.2 substantially match the shape, radii, and curvature associated with the shield 102.4, which is shown in FIGS. 2-4. This design enables the electronics mount 102.2.2 to act as a skull or a supporting member for the shield 102.4, which beneficially enables a thinner shield to be used than the shield that would have to be used if the mount 102.2.2 had a different configuration, provides rigid mounting locations for the cameras and antennas, and enables the displays to be positioned as close as possible to the shield 102.4.

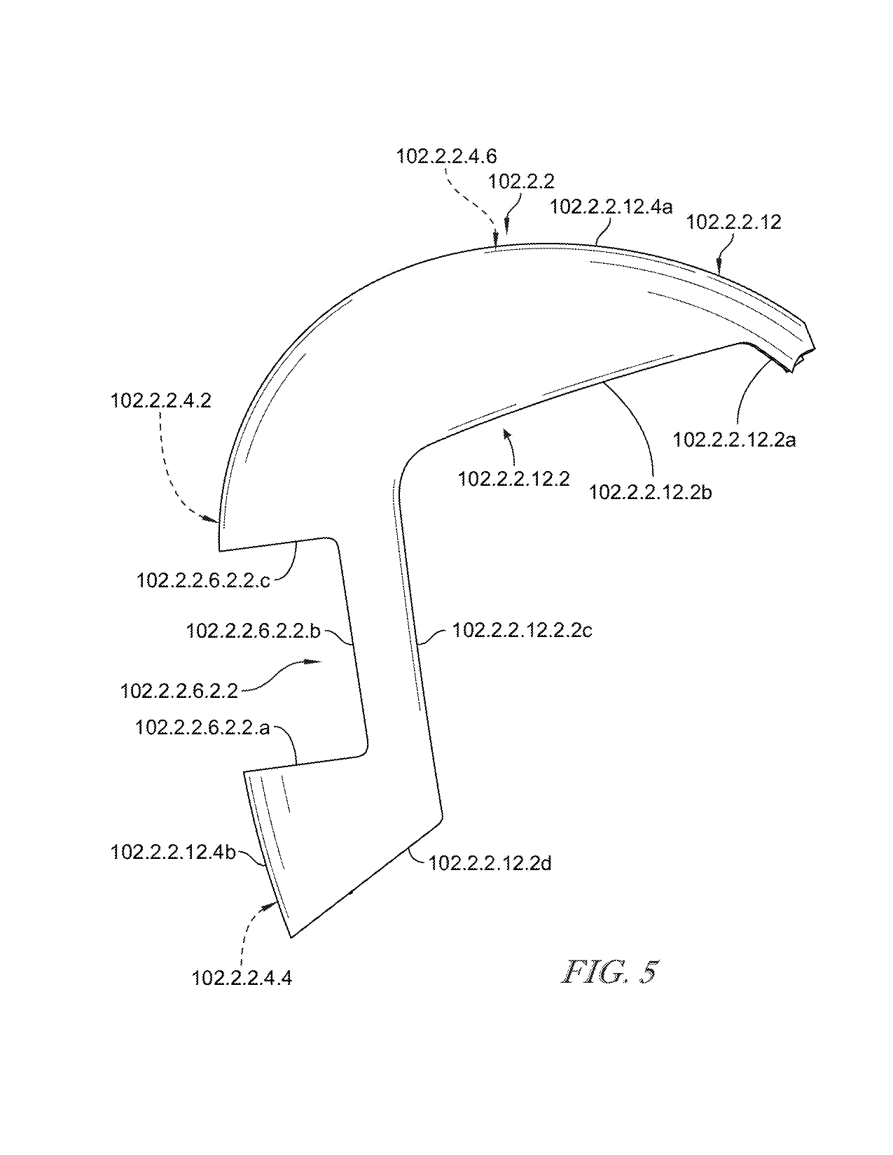

The electronics mount 102.2.2 is configured to include: (i) a plurality of display openings (e.g., for a front or forward-facing display 108.4.2, a right side display 108.4.4, and a left side display 108.4.6) that are configured to receive an extent of the displays that are contained in the electronics assembly 108, (ii) a first plurality of sensor openings (e.g., for an upper camera 108.2.2, a lower camera 108.2.4, and a top camera 108.2.6) that are designed to receive at least one sensor of the electronics assembly 108, and (iii) mounts for the sensors and displays of the electronics assembly 108. In particular and as shown in FIGS. 5-7: (i) the plurality of display openings formed in the electronics mount 102.2.2 includes two display openings 102.2.2.6.2.2, 102.2.2.6.2.4 and (ii) the first plurality of sensor openings formed in the electronics mount 102.2.2 includes three sensor openings 102.2.2.4.2, 102.2.2.4.4, 102.2.2.4.6. The first plurality of sensor openings formed in the shell 102.2 are positioned and sized such that they align with a second plurality of sensor apertures formed in the shield 102.4, as described below, so that the lenses of the cameras and other sensors are unobstructed when the shield 102.4 is overmolded onto the shell 102.2.

The display openings in the electronics mount 102.2.2 include: (i) a front display opening 102.2.2.6.2.2 located in or near the orbital region, the nasal region, and the oral region of the head portion 10.1, and (ii) a first side display opening 102.2.2.6.2.4 located in or near the parietal region and the temporal region of the head on the right side of the head portion 10.1. The front display opening 102.2.2.6.2.2 takes up some or most of the orbital, nasal, and oral regions of the head such that the front display 108.4.2 is the front face of the robot's head portion 10.1. In other embodiments, the front display opening 102.2.2.6.2.2 may take up (i) the orbital region only, (ii) the orbital and nasal regions, or (iii) the orbital and nasal regions and part of the frontal region. The side display opening 102.2.2.6.2.4 is located above the auricular region of the head.

The electronics mount 102.2.2 has sensor mounts and at least one display mount to properly position the sensors 108.2.2, 108.2.4, 108.2.6 and displays 108.4.2, 108.4.4, 108.4.6 within the sensor and display openings in the electronics mount 102.2.2. In other embodiments, the sensors and displays may be mounted to a PCB mounting member instead of the electronics mount 102.2.2. The sensor mounts are located in the respective regions of the sensor openings 102.2.2.4.2, 102.2.2.4.4, 102.2.2.4.6. The display mount is below the front display 108.4.2.

The front display 108.4.2 may be substantially rectangular and may have a curvilinear screen. This curved design permits the inclusion of a larger display with a greater surface area compared to a flat screen, which increases the amount of information that can be conveyed, such as robot status, sensor data, and operational alerts. This information is displayed using generic blocks or shapes rather than anthropomorphic features like eyes or a mouth. In addition to the main display 108.4.2, two side-facing displays are included to show indicia such as the identification number/serial number, battery life, current task, any safety indicia, and/or any other information associated with the humanoid robot 1. Because the shield 102.4 that covers these display openings is made from a transparent or semi-transparent material, information rendered on the displays 108.4.2, 108.4.4, 108.4.6 is visible through the shield 102.4 to an observer.

The opening 102.2.2.6.2.2 for the front display 108.4.2 formed in the electronics mount 102.2.2 may include edges 102.2.2.6.2.2a-c and be shaped with contours around said display opening 102.2.2.6.2.2 to receive the curved shape of the display 108.4.2 without obstructing the view. As illustrated in FIG. 5, a first edge 102.2.2.6.2.2a is a bottom edge, edge 102.2.2.6.2.2c is a top edge opposite of edge 102.2.2.6.2.2a, edge 102.2.2.6.2.2b is a right edge, and the left edge is opposite edge 102.2.2.6.2.2b. The number of edges 102.2.2.6.2.2a-c depends on the number of edges of the display 108.4.2 and matches the number of edges of the display 108.4.2. The electronics mount 102.2.2 may taper and/or include additional contours between the display opening 102.2.2.6.2.2 and the rim. The side displays 108.4.4, 108.4.6 may be rectangular with no curvature such that the left and right-side displays 108.4.4, 108.4.6 are planar. Alternatively, the side displays 108.4.4, 108.4.6 may have a curvature like the front display 108.4.2 to match or mimic the shape/curvature of the head portion 10.1; however, the curvature may be less than the curvature of the front display 108.4.2. The openings 102.2.2.6.2.4 for displays 108.4.4, 108.4.6 formed in the electronics mount 102.2.2 may be shaped with contours around said display openings to receive the displays without obstructing the view.

The sensor openings in the electronics mount 102.2.2 include: (i) an upper sensor opening 102.2.2.4.2 located in or near the frontal region of the head portion 10.1, (ii) a lower sensor opening 102.2.2.4.4 located in or near the oral region and the mental region of the head portion 10.1, and (iii) a top sensor opening 102.2.2.4.6 located on the top of the head portion 10.1 in or near the parietal region of the head portion 10.1. The upper, lower, and top sensor openings 102.2.2.4.2, 102.2.2.4.4, 102.2.2.4.6 in the electronics mount 102.2.2 are vertically aligned in the sagittal plane (P_{S}) of the robot (and the head portion 10.1) when the robot (or head portion 10.1) is in a natural or original upright position. In particular, the upper, lower, and top sensor openings 102.2.2.4.2, 102.2.2.4.4, 102.2.2.4.6 are horizontally centered in the head portion 10.1, but are not vertically centered in the head. Instead, said upper and lower sensor openings 102.2.2.4.2, 102.2.2.4.4 are vertically positioned relative to the center of the head or moved towards the chin portion (i.e., the mental region) of said head portion 10.1, while said top opening 102.2.2.4.6 is at the top of the head.

As discussed above, the electronics mount 102.2.2 may be opaque or may have regions that are opaque to help hide the electronics within the head housing 102. In embodiments where the shell 102.2 is formed from an opaque material and the shield 102.4 is formed from a transparent or semi-transparent material, the opaque shell 102.2 conceals wiring, circuit boards, and other internal components from external view while the transparent or semi-transparent shield 102.4 permits the displays to be visible from outside the head housing 102. Additionally, the electronics mount 102.2.2 may be injection molded or 3D printed and may include any known polymer material or other material, including urethanes, PMMA, ABS, nylons, polyamides, polycarbonate (PC), polypropylene (PP), high-density polyethylene (HDPE), polystyrene (PS), polyvinyl chloride (PVC), thermoplastic elastomers (TPE), polyethylene terephthalate (PET), polybutylene terephthalate (PBT), polyoxymethylene (POM or acetal), epoxy resins, silicone rubber, polyimides (PI), acrylics, polyethylene (PE), liquid crystal polymers (LCP), phenolic resins, glass-filled nylons, carbon fiber reinforced plastics (CFRP), glass fiber reinforced plastics (GFRP), thermoplastic polyurethane (TPU), metal-plastic hybrids, biodegradable plastics (e.g., PLA), conductive polymers (e.g., PANI), any combination thereof, or any other similar material. Further, it should be noted that the electronics mount 102.2.2 may include nuts or threaded fasteners that are molded or secured within the electronics mount 102.2.2 during the formation of said electronics mount 102.2.2.

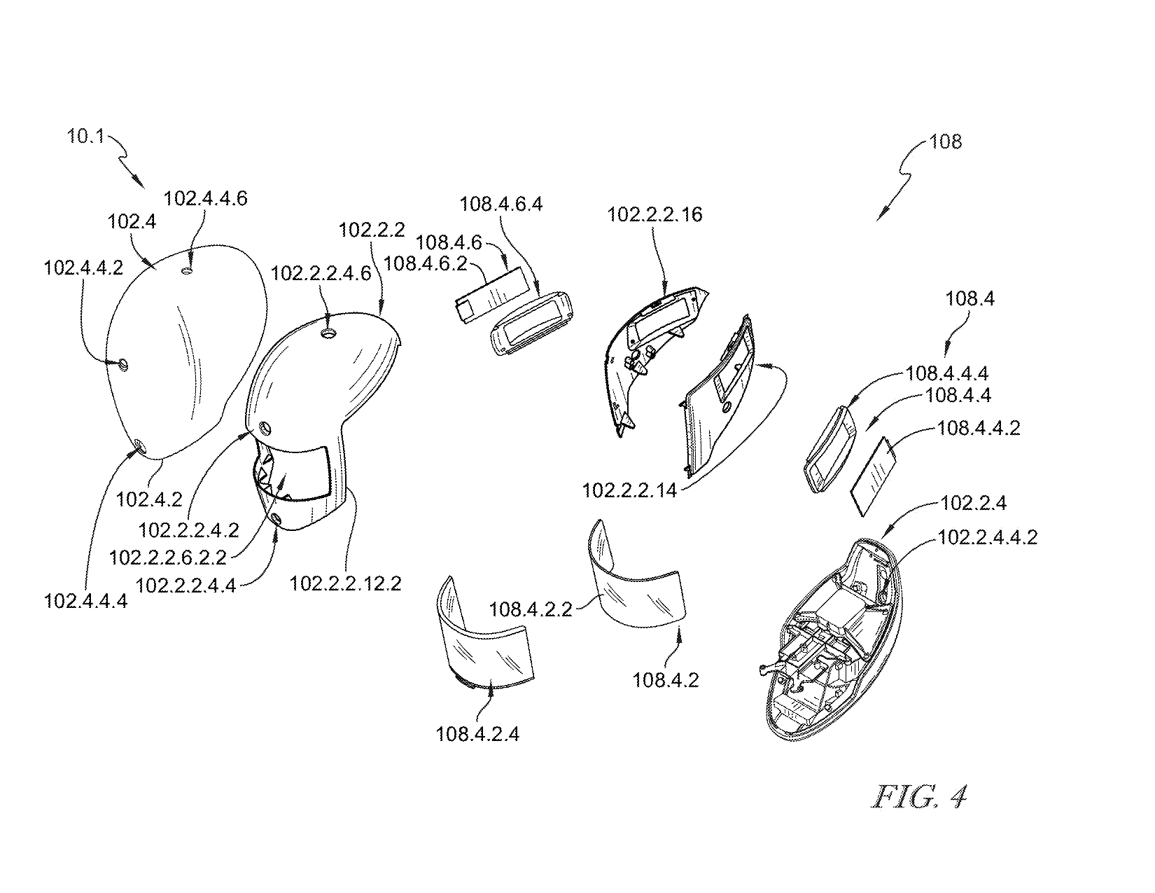

As shown in FIGS. 4-5, the electronics mount 102.2.2 is modular and subdivided into multiple pieces. The electronics mount 102.2.2 includes: (i) a main section 102.2.2.12 and (ii) display housing sections 102.2.2.14, 102.2.2.16. The display housing sections 102.2.2.14, 102.2.2.16 are formed as separate components and, as described in further detail in the manufacturing section below, are attached to the shell 102.2 after the shield 102.4 has been overmolded onto the shell 102.2 and the unitary head housing structure has been released from the injection mold machine. The main section 102.2.2.12 of the electronics mount 102.2.2 extends: (i) from a crown region of the head portion 10.1 to the chin region, (ii) around the auricular region, (iii) around the occipital region, and (iv) around the lower extent of the parietal region. In other words, the main section 102.2.2.12 does not form part of the rear shape of the head. Rather, the display housing sections 102.2.2.14, 102.2.2.16 form or extend into the auricular region, the occipital region, and the lower extent of the parietal region. Together the different sections enable the electronics mount 102.2.2 to act as a skull or a supporting member for the shield 102.4. In other embodiments, the electronics mount 102.2.2 may be subdivided into more or fewer pieces. Once the display housing sections 102.2.2.14, 102.2.2.16 are attached to the shell 102.2, the display housing sections 102.2.2.14, 102.2.2.16 are positioned between the shell 102.2 and the shield 102.4 such that the shield 102.4 covers and protects the display housing sections 102.2.2.14, 102.2.2.16.

As shown in FIGS. 4-5, the edges of the different sections 102.2.2.12, 102.2.2.14, 102.2.2.16 of the electronics mount 102.2.2 cooperate to form the lower edge that is configured to interface with the support frame 102.2.4. The main section 102.2.2.12 has edges 102.2.2.12.2a-d that each interface with an edge 102.2.2.14.2, 102.2.2.16.2 of the corresponding display housing section 102.2.2.14, 102.2.2.16. A first edge 102.2.2.12.2a starts in the lower parietal region and above the occipital region and extends upward towards the upper parietal region to the second edge 102.2.2.12.2b. The second edge 102.2.2.12.2b extends sloping downward from the first edge 102.2.2.12.2a, passing through the forehead region and/or the temporal region, to the third edge 102.2.2.12.2c in the forehead region. The third edge 102.2.2.12.2c extends downward from the second edge 102.2.2.12.2b in the forehead region, through the through the temporal region, the zygomatic region, the buccal region, to the fourth edge 102.2.2.12.2d in the buccal region. The fourth edge 102.2.2.12.2d extends from the third edge 102.2.2.12.2c in the buccal region downward and forwardly to the chin region to meet an outer surface edge 102.2.2.12.4 of the electronics mount 102.2.2. The fourth edge 102.2.2.12.2d is aligned with a fifth edge 102.4.2e of the shield 102.4 (discussed below in more detail) and has a length less than the length of the fifth edge 102.4.2e of the shield 102.4. The outer surface edge 102.2.2.12.4 includes a first outer surface edge 102.2.2.12.4a extending from the rear of the forehead region to the top edge 102.2.2.6.2.2c and a second outer surface edge 102.2.2.12.4b extending downward from the bottom edge 102.2.2.6.2.2a to the fourth edge 102.2.2.12.2d.

The edges 102.2.2.14.4, 102.2.2.16.4 of the display housing sections 102.2.2.14, 102.2.2.16 cooperate with the edges 102.2.2.12.2 of the main section 102.2.2.12. The edges 102.2.2.14.4, 102.2.2.16.4 (i) start in the lower parietal region and above the occipital region, (ii) continue sloping downward and forwardly as they pass through the occipital region, the auricular region, the mastoid region, the parotideomasseteric region, the buccal region, and (iii) end in the chin region. Each edge 102.2.2.14.4, 102.2.2.16.4 is contoured to complement the corresponding edge of the main section 102.2.2.12 to which it interfaces. The mating of these edges forms a substantially continuous outer profile that cooperates with the interior surface of the shield 102.4.

The main section 102.2.2.12 of the electronics mount 102.2.2 is configured to include: (i) the front display opening 102.2.2.6.2.2 located in or near the orbital region, the nasal region, and the oral region of the head portion 10.1 that is configured to receive an extent of the front display 108.4.2 in the electronics assembly, (ii) the upper, lower, and top sensor openings 102.2.2.4.2, 102.2.2.4.4, 102.2.2.4.6 that are designed to receive at least one sensor of the electronics assembly 108, and (iii) mounts for the sensors and displays of the electronics assembly. The display housing sections 102.2.2.14, 102.2.2.16 of the electronics mount 102.2.2 are each configured to include: (i) the display opening 102.2.2.6.2.4 that is configured to receive an extent of a display that is contained in the electronics assembly and (ii) the left-side and right-side sensor openings that are configured to receive at least one sensor of the electronics assembly 108. The display surfaces 108.4.4.2, 108.4.6.2 of the left and right-side displays 108.4.4, 108.4.6 may be flat or planar. In other embodiments, said side displays 108.4.4, 108.4.6 may have a convex curvature that conforms with the curvature of the housing sections 102.2.2.14, 102.2.2.16.

### 2. Shield

The shield 102.4 is configured to cover, encase, surround, or overlay the shell 102.2 and the electronics assembly 108, as shown in FIGS. 2-11. The shield 102.4 may be made from a transparent or semi-transparent material so that displays 108.4.2, 108.4.4, 108.4.6 mounted in the internal support assembly may be viewed therethrough. In other embodiments, the shield 102.4 may be transparent in some regions and not transparent in other regions. In embodiments where the shell 102.2 is formed from an opaque first material and the shield 102.4 is formed from a transparent or semi-transparent second material, the shield 102.4 provides optical clarity for viewing the displays while the opaque shell 102.2 conceals internal wiring, circuit boards, and other non-display components from external view.

Further, shield 102.4 may be coated, etched, or formed with a plurality of layers in a manner that improves durability, increases sensor accuracy, filters one or more specific wavelengths, reduces glare, enhances appearance, reduces fogging, makes the shield 102.4 easier to clean, or protects it from cleaning products. It should be understood that this disclosure is not limited to just the information that is disclosed within any incorporated applications but instead should include any compositions, shapes, layer numbers, and compositions of layers that are known in the art or are obvious in light of what is known in the art. The shield 102.4 may also include one or more functional elements embedded therein, as described in the manufacturing section below. Such embedded functional elements may include a transparent conductive film, a reinforcement grid, an antenna structure, or a microelectronic component, each of which may be introduced during the overmolding process.

The shield 102.4 or an extent of the shield 102.4 may have a substantially uniform thickness, which may be equal to or greater than 1 mm and preferably greater than 2 mm. Additionally, the shield 102.4 may be optically correct and may not be a corrective lens. As such, the shield 102.4 has a dioptric power of less than 0.25 diopters, preferably less than 0.12 diopters, and most preferably less than 0.06 diopters, to ensure an undistorted view of the internal displays. The shield 102.4 may have a reverse or negative pantoscopic tilt, a forward or positive pantoscopic tilt, or no pantoscopic tilt relative to the coronal plane (P_{C}).

Accordingly, the shield 102.4 may be made from or may include polycarbonate (PC), acrylic (PMMA), Trivex, nylon, Gorilla Glass (aluminosilicate glass), thermoplastic polyurethane (TPU), high-grade optical glass, CR-39, polyethylene terephthalate (PET), polystyrene, fused silica (quartz glass), borosilicate glass, polyurethane, cellulose acetate, polyvinyl chloride (PVC), cellulose acetate butyrate (CAB), polyvinyl butyral (PVB), optical-grade resin, sapphire glass, polyetherimide (PEI), Lexan, thermoset plastics, other anti-scratch coated plastics, or any other similar material that is known in the art. Also, the shield 102.4 may be manufactured via injection molding, 3D printing, or overmolded onto an electronics mount 102.2.2. Wherein said overmolded shield 102.4 may be manufactured using a multi-part mold design, multiple injection shots, or other molding techniques (e.g., gas-assisted injection molding, liquid injection molding, thermoforming, and/or reaction injection molding). Further, said molding technique, mold design, and shot configuration may be determined using mold flow analysis and/or simulation. The method of manufacturing the shield 102.4 is discussed in further detail below.

As shown in FIGS. 2-11, the shield 102.4 may include a curved surface 102.4.8 and be configured to cover the electronics mount 102.2.2 and couple to the support frame 102.2.4 at the rim. The shield 102.4 is shaped to resemble the form of the head portion 10.1, providing a substantially continuous surface between the sections of the housing 102. The curvature of the curved surface 102.4.8 may vary and have different curvatures (i.e., radii and arcs) at different positions along the shield 102.4, resulting in a freeform curved surface that does not conform to a single geometric primitive such as a sphere, cylinder, or cone. Although the illustrative embodiment shows the shield 102.4 is sized to match or substantially match the electronics mount 102.2.2, the shield 102.4 may occupy any portion or ratio of the robot's head and may have any configuration. The shield may: (i) wrap from the front of the head into the side regions of the head portion 10.1, (ii) extend into the chin area or cover the entire chin area, and (iii) may have a non-uniform rear edge (edges 102.4.2a-e). The first edge 102.4.2a may extend from a rear end of the curved surface 102.4.8 sloping downward and forward to the second edge 102.4.2bin the parietal region. The second edge 102.4.2b extends sloping downward, greater than the slope of the first edge 102.4.2a, from the first edge 102.4.2a to the third edge 102.4.2c in the parietal region. The third edge 102.4.2c extends sloping downward, less than the slope of the second edge 102.4.2b, from the parietal region past the ear or auricular region and into the zygomatic region to the fourth edge 102.4.2d. The fourth edge 102.4.2d extends sloping downward, similar to the slope of the second edge 102.4.2b, from the zygomatic region to the fifth edge 102.4.2e in the buccal region. The fifth edge 102.4.2e extends sloping downward, similar to the slope of the third edge 102.4.2c, from the buccal region to the curved surface 102.4.8 at the chin. Other edge configurations are also possible. The disclosed shield may be curved in two directions (e.g., vertically and horizontally) or may be a freeform design that may include multiple curves.

The shield 102.4 (i) extends from the chin or mental region of the robot's head portion 10.1 to the parietal region of the robot's head portion 10.1 and (ii) wraps around the lateral sides up to or past the ear or auricular region of the robot's head portion 10.1. The shield 102.4 does not extend into the occipital region or the mastoid region of the robot's head portion 10.1 but does extend partway into the parotid or parotideomasseteric region and buccal region of the robot's head portion 10.1. In other embodiments, the entire head may be a shield, the shield may not extend as far up as or past the auricular region, the shield may not extend into the parietal region, or the shield may extend into the parietal region. Additionally, the disclosed shield 102.4 may occupy between 90% and 25% of the head portion 10.1 and may be curved in at least two directions (e.g., vertically and horizontally), such that the shield 102.4 is curved in both a vertical direction and a horizontal direction across the head housing 102. In some embodiments, the shield 102.4 and the display may be integrated into a single component or may be formed from a plurality of components.

The shield 102.4 includes a second plurality of sensor apertures 102.4.4.2, 102.4.4.4, 102.4.4.6 which are configured to align with the first plurality of sensor openings 102.2.2.4.2, 102.2.2.4.4, 102.2.2.4.6 in the electronics mount 102.2.2 of the shell 102.2. The alignment between the second plurality of sensor apertures of the shield 102.4 and the first plurality of sensor openings of the shell 102.2 is achieved during the overmolding process, in which the shield 102.4 is molded onto the shell 102.2 while the shell 102.2 remains on the core of the injection mold machine. The formation of the combination of the sensor apertures 102.4.4.2, 102.4.4.4, 102.4.4.6 and sensor openings 102.2.2.4.2, 102.2.2.4.4, 102.2.2.4.6 enables the lenses of the upper camera 108.2.2, the lower camera 108.2.4, and the top camera 108.2.6 to be unobstructed. This configuration reduces potential distortion of the images captured by the cameras 108.2.2, 108.2.4, 108.2.6, which in turn reduces computational processing, lowers battery usage, and minimizes heat generation from the image signal processor.

The shield 102.4 may have the same or a different curvature than the displays 108.4.2, 108.4.4, 108.4.6 at the respective locations of these displays 108.4.2, 108.4.4, 108.4.6 so that the shield 102.4 is optically correct. This provides a clearer, crisper, and more accurate view of the displays 108.4.2, 108.4.4, 108.4.6. The optically correct shield 102.4 mitigates distortions, aberrations, and visual artifacts, providing viewers of the displays 108.4.2, 108.4.4, 108.4.6 with an unobstructed and accurate view of the displays 108.4.2, 108.4.4, 108.4.6, while still protecting the displays 108.4.2, 108.4.4, 108.4.6 and other electronic components within the head portion 10.1. Because the shield 102.4 is formed from a transparent or semi-transparent material, the shield 102.4 permits the displays to be visible while serving as an impact-resistant barrier between the external environment and the displays.

### 3. Support Frame

The support frame 102.2.4, also referred to as a jaw member or rear/lower support frame 102.2.4, defines (i) a rear portion of the head portion 10.1 (e.g., an extent of the parietal region and the occipital region) and is designed to couple the head actuator assembly and (ii) a neck cover to the head portion 10.1. The support frame 102.2.4 is also designed to support the internal support assembly within the head portion 10.1. The support frame 102.2.4 has an upper edge that: (i) extends rearward from the chin region along a jaw line towards the occipital regions of the head portion 10.1, and (ii) complements the lower edge 102.4.2 of the shield 102.4. The support frame 102.2.4 also has a lower edge 102.2.4.10 that: (i) extends rearward from the chin region along a jaw line towards the occipital regions of the head portion 10.1, and (ii) complements the upper edge 102.2.6.4 of the upper securement member 102.2.6 of the neck portion 10.2.

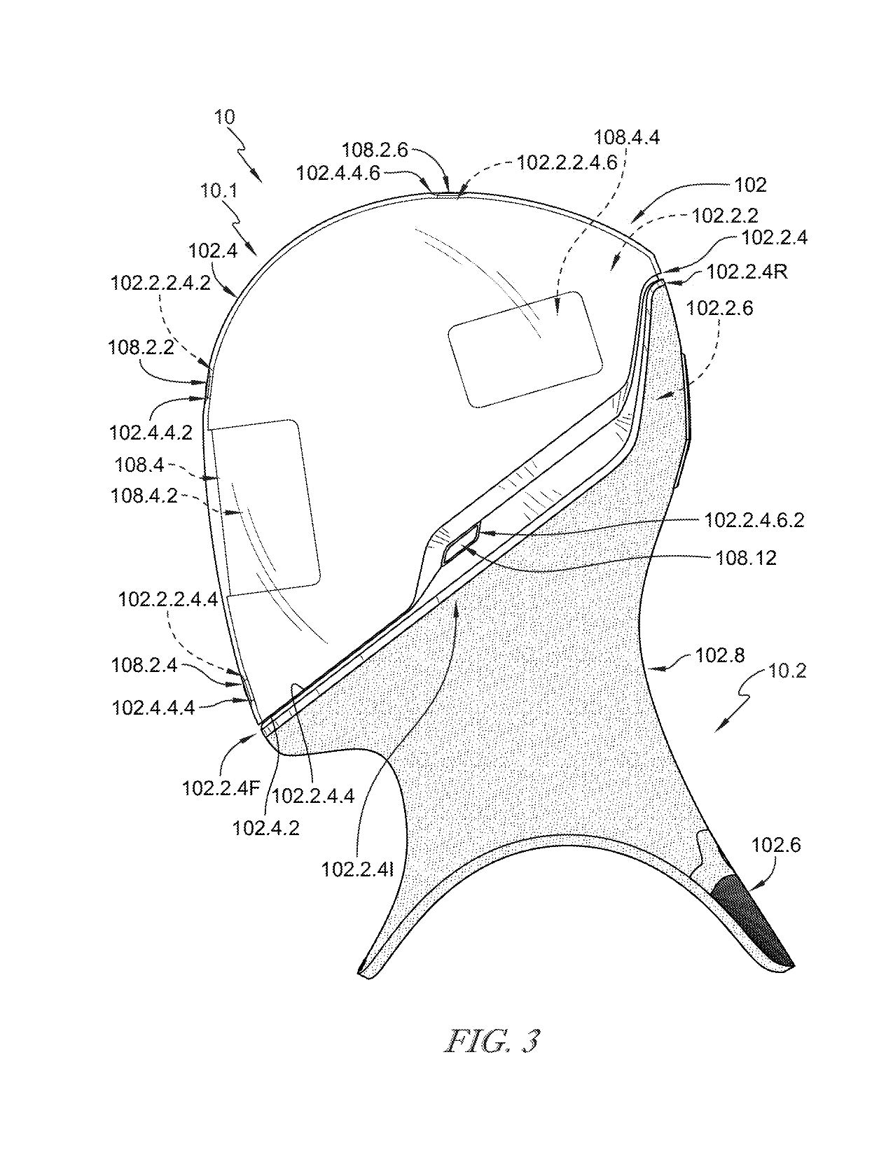

To complement said lower edge of the shield 102.4, the support frame 102.2.4 includes a frontal extent 102.2.4F, an intermediate extent 102.2.4I, and a rear extent 102.2.4R as shown in FIG. 3. The frontal extent 102.2.4F is arranged below a front extent of the electronics mount 102.2.2, the intermediate extent 102.2.4I is substantially parallel with the frontal extent 102.2.4F (but not co-linear with), and the rear extent 102.2.4R has a slope that is significantly greater than the slope associated with the frontal extent 102.2.4F or intermediate extent 102.2.4I. In other words, the frontal extent 102.2.4F has a first slope in the first position, the intermediate portion 102.2.4I has a second slope that is approximately equal to the first slope and is offset from said frontal extent 102.2.4F, and the rear extent 102.2.4R has a third slope that is greater than the first and second slopes. In other embodiments, the upper edge 102.2.4.8 of the support frame 102.2.4 may include more extents (e.g., between 4and 30) or fewer extents (e.g., between 1and 2). Further, the slopes of the extents may be different.

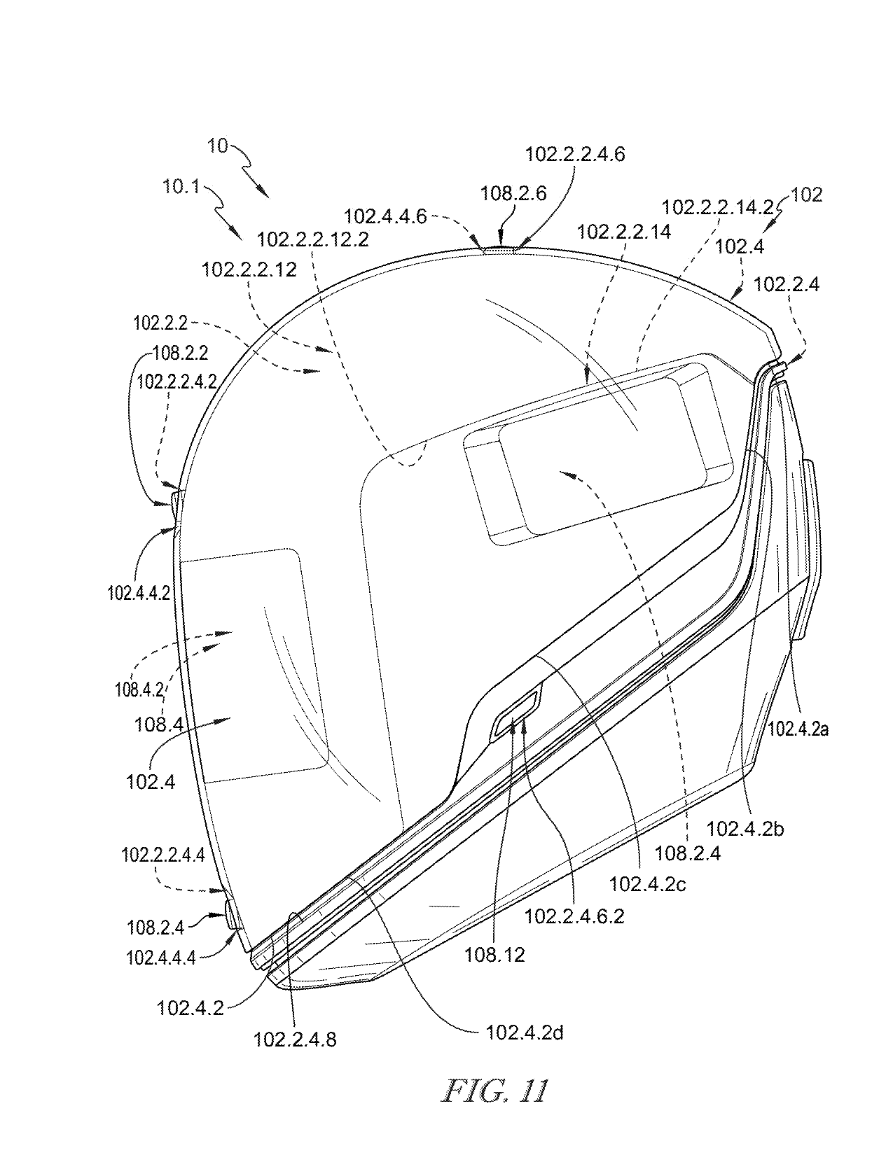

As shown in FIG. 3, because the intermediate extent 102.2.4I of the upper edge 102.2.4.8 is offset from a line that is co-linear with and extends rearward from the frontal extent 102.2.4F of the upper edge 102.2.4.8, a lateral space is provided between the upper edge 102.2.4.8 of the support frame 102.2.4 and the lower edge 102.4.2 of the shield 102.4. The lateral space extends rearward from the front of the auricular region, through an extent of the mastoid region, and into the occipital region. The lateral space is not flush with the exterior surface of the shield 102.4. Instead, said lateral space includes a "V-shaped" recess as shown in FIG. 11. Said "V-shaped" recess includes an aperture that is formed in an upper extent of said "V-shaped" recess, wherein the aperture is designed to allow air to flow into the head portion 10.1 in order to cool said head portion 10.1. In addition to said aperture, a light emitter 108.12 is also positioned within the "V-shaped" recess.

As discussed above, the support frame 102.2.4 not only includes an extent (e.g., the frontal extent 102.2.4F) that is positioned within the chin or mental region, but it also includes a substantial extent (e.g., the rear extent 102.2.4R) that is positioned in the occipital region. By positioning an extent of said support frame 102.2.4 in the occipital region, the support frame 102.2.4: (i) reduces the size of the shield 102.4, which reduces the number of curves contained in the shield 102.4 and thereby reducing the complexity of manufacturing the shield 102.4, (ii) enables the rear camera 108.2.8 to be positioned in the support frame 102.2.4, (iii) increases ease of assembly, and (iv) increases the amount of non-transparent material that is included in the head housing 102. It should be understood that in alternative embodiments, the size of the support frame 102.2.4 may be increased to extend into the zygomatic region or extend further into the temporal region, parotideomasseteric region, and parietal region.

The support frame 102.2.4 is configured to include an opening 102.2.4.4.2 for at least one sensor (e.g., rear camera 108.2.8) of the electronics assembly 108 and an opening 102.2.4.6.2 for at least one indicator light 108.12. The sensor opening 102.2.4.4.2 in the support frame 102.2.4 is also vertically aligned in the sagittal plane (P_{S}) of the robot 1 (and the head portion 10.1) when the robot 1 (or the head portion 10.1) is in a natural or original upright position, as shown in FIG. 3. In particular, the upper sensor opening 102.2.2.4.2, the lower sensor opening 102.2.2.4.4, the top sensor opening 102.2.2.4.6, and the rear sensor opening 102.2.4.4.2 are horizontally centered in the head portion 10.1. The indicator opening 102.2.4.6.2 is located in the auricular region of the head portion 10.1.

The support frame 102.2.4 may be made from materials such as silicone elastomers, thermoplastic polyurethane (TPU), shape-memory polymers (SMPS), polydimethylsiloxane (PDMS), polyurethane, liquid silicone rubber (LSR), urethane rubber, vinyl (PVC) skin, soft thermoplastic elastomers (TPE), elastomeric alloys, acrylonitrile butadiene styrene (ABS) blends, high-density polyethylene (HDPE) blends, conductive polymers, carbon nanotube-infused elastomers, magnetic shape-memory alloys, electroactive polymers (EAPS), styrene-butadiene rubber (SBR), thermoplastic vulcanizates (TPV), polyurea elastomers, medical-grade synthetic skin materials, thermoplastic olefins (TPO), fluoroelastomers, chloroprene rubber, ethylene propylene diene monomer (EPDM) rubber, polyacrylamide hydrogels, polycaprolactone (PCL), photocurable resins, elastomeric composites, phosphorescent elastomers, thermochromic materials, electrostrictive polymers, piezoelectric polymers, superelastic alloys, microcellular foams, hyperelastic materials, viscoelastic gels, nanocomposite elastomers, fabrics, metal, other similar plastics or polymers, any combination of the above, and/or any other similar material known in the art. The support frame 102.2.4 may be manufactured using any known method, including: molding, such as injection or dip molding, casting, 3D printing (additive manufacturing), dip molding and coating, spray coating, lamination and layering, electrospinning, sculpting and machining, thermoforming, any combination of the above, and/or any other known method. In alternative embodiments, the support frame 102.2.4 may be manufactured using the same injection molding process and the same injection mold machine 700 that is used to manufacture the shell 102.2 and the shield 102.4, or the support frame 102.2.4 may be manufactured using a separate and distinct molding process.

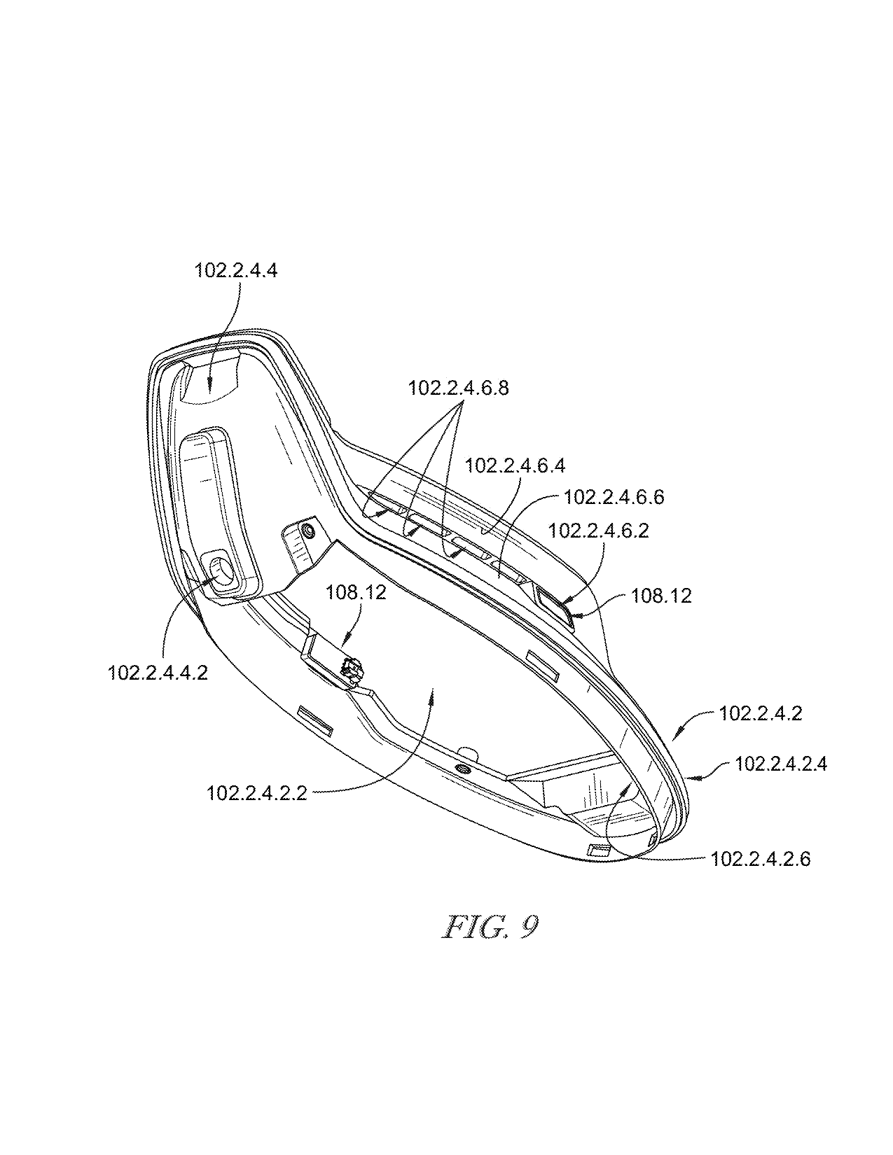

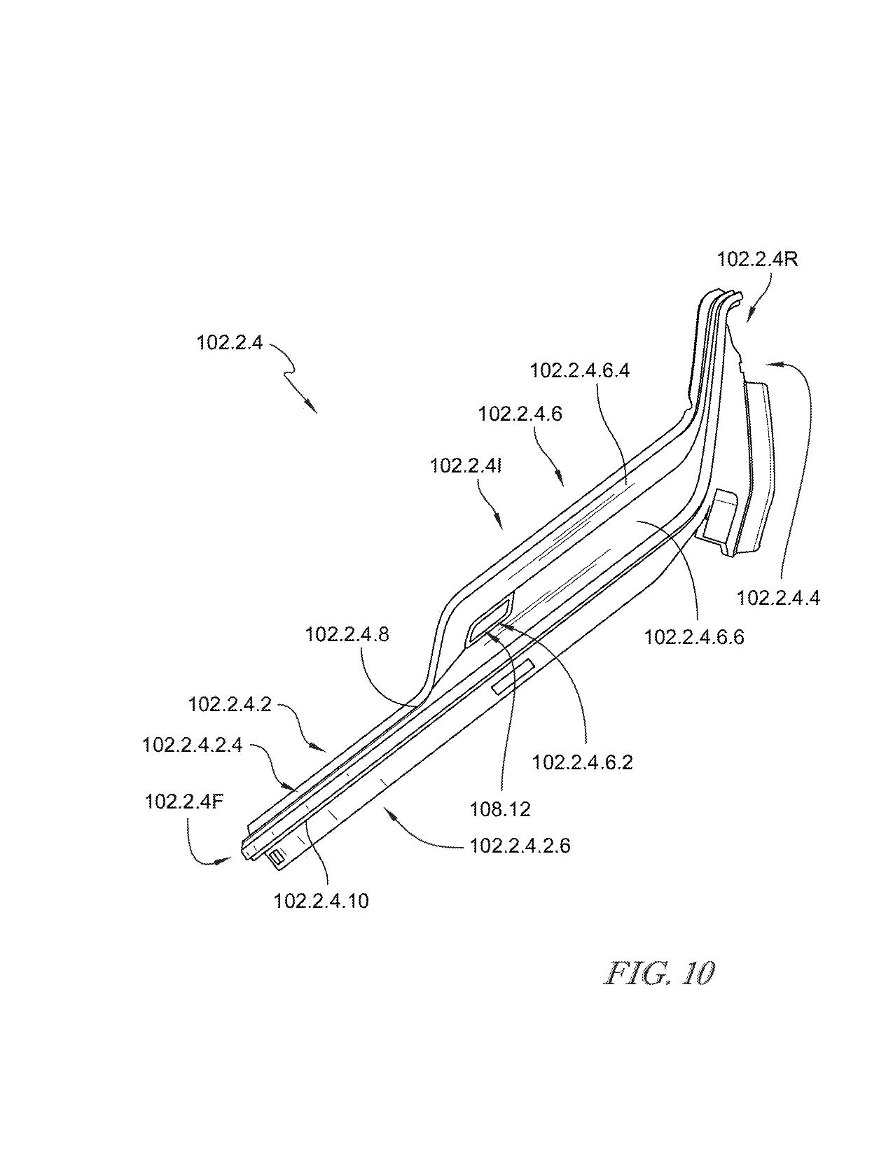

As shown in FIGS. 9-10, the support frame 102.2.4 includes: (i) a frame base member 102.2.4.2, (ii) a back frame plate 102.2.4.4, and (iii) left and right frame walls 102.2.4.6. The frame base member 102.2.4.2 extends around the front, rear, left, and right extents of the head portion 10.1 to form an opening 102.2.4.2.2. The back frame plate 102.2.4.4 extends from a portion of the frame base member 102.2.4.2 and defines a majority of the rear extent 102.2.4R of the support frame 102.2.4. The left and right frame walls 102.2.4.6 extend upwardly from the frame base member 102.2.4.2 on the left and right extents of the head portion 10.1 at or near the intermediate extent 102.2.4I of the support frame 102.2.4. The frame base member 102.2.4.2 and the left and right frame walls 102.2.4.6 cooperate to define the upper edge 102.2.4.8 of the support frame 102.2.4, while the frame base member 102.2.4.2 defines the entirety of the lower edge 102.2.4.10.

The frame base member 102.2.4.2 is formed to include: (i) an outer rim section 102.2.4.2.4 and (ii) a mounting section 102.2.4.2.6 as shown in FIGS. 9-10. The outer rim section 102.2.4.2.4 extends around the front, rear, left, and right extents of the head portion 10.1 to form an opening 102.2.4.2.2. The outer rim section 102.2.4.2.4 is visible when the upper securement member 102.2.6 of the neck portion 10.2 is attached to the support frame 102.2.4. The mounting section 102.2.4.2.6 extends downward from at least a portion of the outer rim section 102.2.4.2.4 and provides the attachment for the upper securement member 102.2.6 of the neck portion 10.2.

The back frame plate 102.2.4.4 is formed to define the sensor opening 102.2.4.4.2. The back frame plate 102.2.4.4 is shaped to define the rear extent 10.1.4 of the head portion 10.1. The upper securement member 102.2.6 of the neck portion 10.2 extends over and covers a majority of the back frame plate 102.2.4.4. As a result, a majority of the back frame plate 102.2.4.4 is not visible when the upper securement member 102.2.6 of the neck portion 10.2 is coupled to the support frame 102.2.4. A portion of the back frame plate 102.2.4.4 formed to include the sensor opening 102.2.4.4.2 remains uncovered.

Each of the left and right frame walls 102.2.4.6 is formed to define the respective indicator opening 102.2.4.6.2. Each frame wall 102.2.4.6 has angled surfaces 102.2.4.6.4, 102.2.4.6.6 to allow space for vent openings 102.2.4.6.8. The angled surface 102.2.4.6.6 extends from the frame base member 102.2.4.2 and the other angled surface 102.2.4.6.4 extends from the surface 102.2.4.6.6 in an opposite direction to form the contour in the frame wall 102.2.4.6. The respective light emitter 108.12 is coupled to the left and right frame walls 102.2.4.6.

### ii. Electronic Components

The electronics assembly 108 contained in the head portion 10.1 may include: (i) a sensor assembly, (ii) a display assembly 108.4, (iii) an antenna assembly, (iv) an illumination assembly that includes at least one, and preferably a plurality of light emitters 108.12, and (v) other electronics (e.g.,IMU, RFID reader, location sensors (e.g.,Global Positioning System (“GPS”), GLONASS, Galileo, QZSS, and/or iBeacon), etc.), and/or PCBs for connecting said electronics. As shown in at least FIG. 11, the components of the electronics assembly 108 may be mounted to the PCB mounting member. Alternatively, or additionally, some of the components of the electronics assembly 108 may be mounted to the electronics mount 102.2.2. For example, the sensors may be mounted to the electronics mount 102.2.2 to align the sensors with the respective sensor openings 102.2.2.4.2, 102.2.2.4.4, 102.2.2.4.6.

The display assembly 108.4 may include one or more displays. The displays may use any known technology or feature including, but not limited to: LCD, LED, OLED, LPD, IMOD, QDLED, mLED, AMOLED, SED, FED, plasma, electronic paper or EPD, MicroLED, quantum dot display, LED backlit LCD, WLCD, OLCD, transparent OLED, PMOLED, capacitive touch display, resistive touch display, monochrome, color, or any combination of the above, or any other known technology or display feature. In the illustrative example, the display assembly 108.4 includes a front display 108.4.2, a left-side display 108.4.6, and a right-side display 108.4.4. In other embodiments, the display assembly 108.4 may include fewer or a greater number of displays. The displays 108.4.2, 108.4.4, 108.4.6 of the electronics assembly 108 may be mounted to the electronics mount 102.2.2 and positioned such that a display opening 102.2.2.6.2.2, 102.2.2.6.2.4, 102.2.2.6.2.6 of the electronics mount 102.2.2 surrounds each display 108.4.2, 108.4.4, 108.4.6. As shown in FIGS. 2-4 and 11, the front display 108.4.2 is mounted to the main section 102.2.2.12 of the electronics mount 102.2.2, and the side displays 108.4.4, 108.4.6 are mounted to the display housing sections 102.2.2.14, 102.2.2.16 of the electronics mount 102.2.2. It should be understood that this application contemplates the use of displays that have different sizes. Alternative display sizes may be used to: (i) reduce the surface area of fragile elements within the robot, (ii) because said robot is not designed to work near humans, (iii) additional area within the head is needed for sensors or other electronics, or (iv) any other reason known by one of skill in the art. The disclosed display may occupy the entire shield 102.4, between 100% and 75% of the shield, between 75% and 50% of the shield, between 50% and 25% of the shield, or less than 25% of the shield. In some examples, the display may utilize the full shield 102.4. The displays disclosed herein may meet the standards described in FDA CFR Title 21 part 1040.10, titled Performance Standards for Light-Emitting Products, and ANSI LIA Z136.1, titled Safe Use of Lasers.

The head illumination assembly includes at least one, and preferably a plurality of light emitters 108.12 located on lateral sides of the head portion 10.1. In certain configurations, the illumination assembly may be designed to visually indicate robot statuses to users viewing the robot 1 from the side. The illumination assembly includes left and right light emitting assemblies 108.12 located in the auricular region of the robot's head portion 10.1. In other embodiments, the light emitting assemblies 108.12 can be located all or partially in a parotid region, an auricular region, a zygomatic region, a parietal region, a frontal region, or a mastoid region so long as the light emitters 108.12 are positioned on a lateral side of the robot's head portion 10.1 so as to be visible to a person standing next to the robot 1. These positions of the light emitting assemblies 108.12 allow users to view the light emitted from said light emitting assemblies 108.12 from the side while the robot 1 is working on a task in an assembly line. Further, the light emitting assemblies 108.12 may face away from the main display 108.4.2 so as not to obstruct the information displayed by the main display 108.4.2 and face away from other sensors so as not to interfere with the sensors. Other regions of the head portion 10.1 where the light emitting assemblies 108.12 are not included are the chin or mental region, orbital region, nasal region, and/or occipital region. Each of the light emitting assemblies 108.12 in the head portion 10.1 includes: (i) a light source or light emitter, and (ii) a diffuser lens covering the light source. The light source and the diffuser lens form a unit that is inserted together into a light housing positioned within the lateral space that includes a "V-shaped" recess formed in the support frame 102.2.4. The light source or emitter can include any known light emitter, including any one or more of the following: laser, LCD, LED, e.g., COB LED, OLED, LPD, IMOD, QDLED, mLED, AMOLED, SED, FED, plasma, electronic paper or EPD, MicroLED, quantum dot display, LED backlit LCD, WLCD, OLCD, transparent OLED, PMOLED, capacitive touch display, resistive touch display, monochrome, color, or any combination of the above, or any other known technology or light feature. It should be understood that in other embodiments, the above disclosed light sources or emitters and/or additional light emitters may be formed in any desirable configuration or used with any other material, structure, or component to form the desirable light emitting assemblies 108.12. Examples of said light emitting assemblies 108.12 that may be formed include fiber optic cables, electroluminescent (EL) wire, laser diodes, neon tubes, cold cathode fluorescent lamps (CCFL), plasma tubes, phosphorescent strips, UV LED strips, infrared LED arrays, light guide panels (LGP), and edge-lit light panels.

### b. Neck Portion

As shown in FIGS. 2-3, the neck portion 10.2 includes: (i) an upper securement member 102.2.6, (ii) a lower securement member 102.6, and (iii) a deformable cover or member 102.8 that is coupled to the upper and lower securement members 102.2.6, 102.6. The lower securement member 102.6 can be formed separate from or integrally with the torso 16, while the upper securement member 102.2.6 can be formed separate from or integrally with the head housing 102. The neck portion 10.2 provides a structural and mechanical connection between the torso 16 and the head portion 10.1, and the components of the neck portion 10.2 cooperate to conceal the actuators and wiring that extend between the torso 16 and the head portion 10.1.

### i. Upper Securement Member

The upper securement member 102.2.6 couples over the support frame 102.2.4. The upper securement member 102.2.6 is shaped to complete a form that resembles a head and to mate with the lower edges of the electronics mount 102.2.2 and the support frame 102.2.4 to enclose a substantial portion of the electronics assembly 108. The upper securement member 102.2.6 includes a central opening for an actuator and an aperture that aligns with the opening 102.2.4.4.2 in the support frame 102.2.4 for the rear camera 108.2.8. The actuator extends through the central opening in the upper securement member 102.2.6. The aperture is configured to align with the sensor opening 102.2.4.4.2 formed in the support frame 102.2.4 so that the lens of the rear camera 108.2.8 is unobstructed. Thereby reducing potential distortion of the images captured by the rear camera 108.2.8, which reduces processing demands, battery usage, and generation of heat.

### ii. Lower Securement Member

The lower securement member 102.6 is coupled to an upper part of the torso 16 and includes an aperture formed therein to receive a speaker. The deformable cover or member 102.8 is configured to wrap around at least an edge portion of the housing 102 and particularly the support frame 102.2.4. In doing so, the deformable cover 102.8 obscures the actuators and other electronics contained in the neck. The neck cover 102.8 may be made from a material (e.g., fabric or deformable plastic) that allows the head to twist in both directions and pitch forward and back without bunching or pulling. It is designed to return to its original state when the head returns to its normal state. For example, said materials may include silicone rubber, thermoplastic elastomers (TPE), polyurethane elastomers, neoprene (polychloroprene), latex rubber, liquid silicone rubber (LSR), elastic fabrics (spandex, lycra), EPDM rubber, nitrile rubber (NBR), polyvinyl chloride (PVC) plastisols, thermoplastic polyurethane (TPU), foamed elastomers, hydrogels, fabric- reinforced elastomers, shape memory polymers, or elastomeric polyesters.

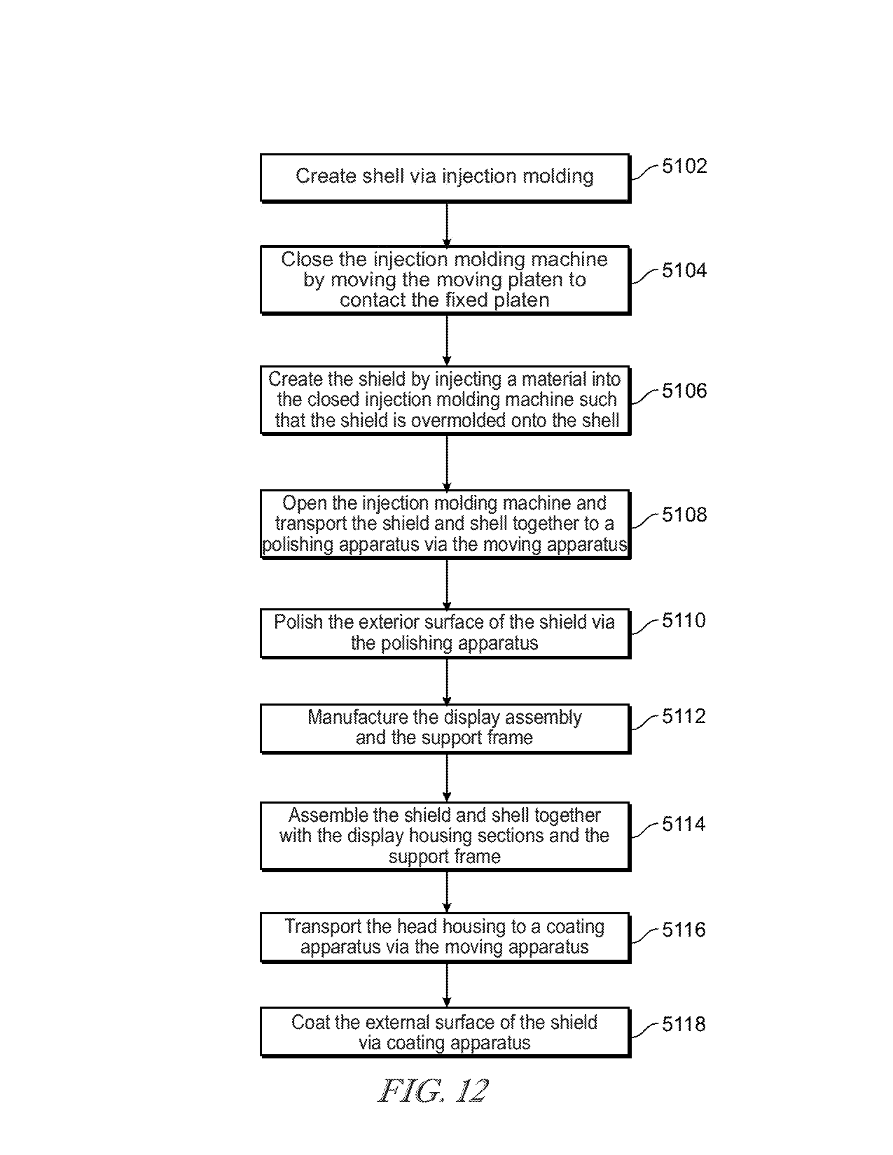

FIG. 12 illustrates a flow chart for the manufacturing process of the head and neck assembly according to one or more embodiments. The manufacturing process for the humanoid robot's head begins with high-precision injection molding to create the core structural components such as the shell 102.2 of the head housing 102 (S102), typically using durable materials like polycarbonate. The shell 102.2 is formed on a first portion of a core 710 within an injection mold machine 700, as described below. The shield 102.4 is then formed and bonded to the shell 102.2 through an overmolding process (S104, S106), which is followed by an automated, robotic polishing and coating procedure (S108 through S118) to achieve a high-quality, optical-grade finish. The resulting combination of the shell 102.2 and the shield 102.4 forms a unitary head housing structure in which the two materials are bonded together during the molding cycle rather than joined in post-production. The coating procedure may enhance durability and functionality by coating the shield 102.4 with various optional optical coatings, such as anti-reflective, scratch-resistant, or hydrophobic layers.

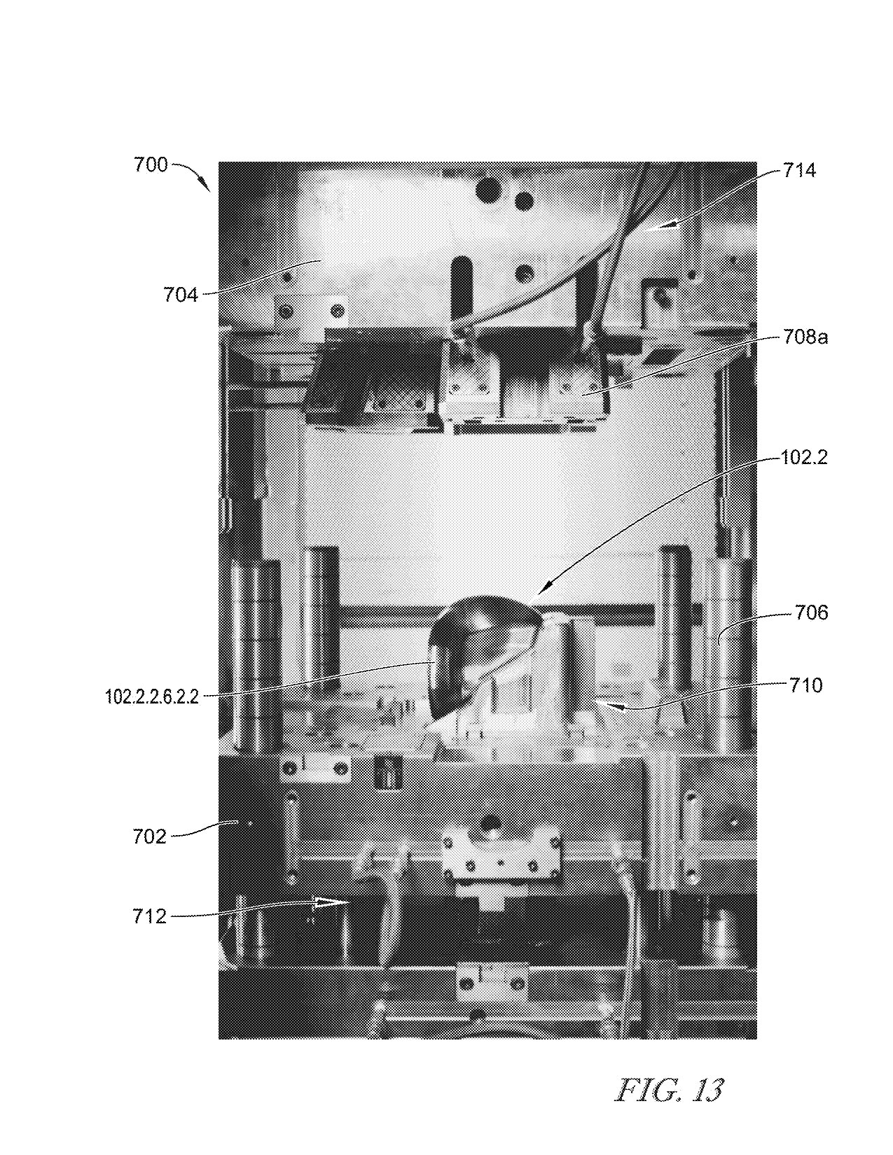

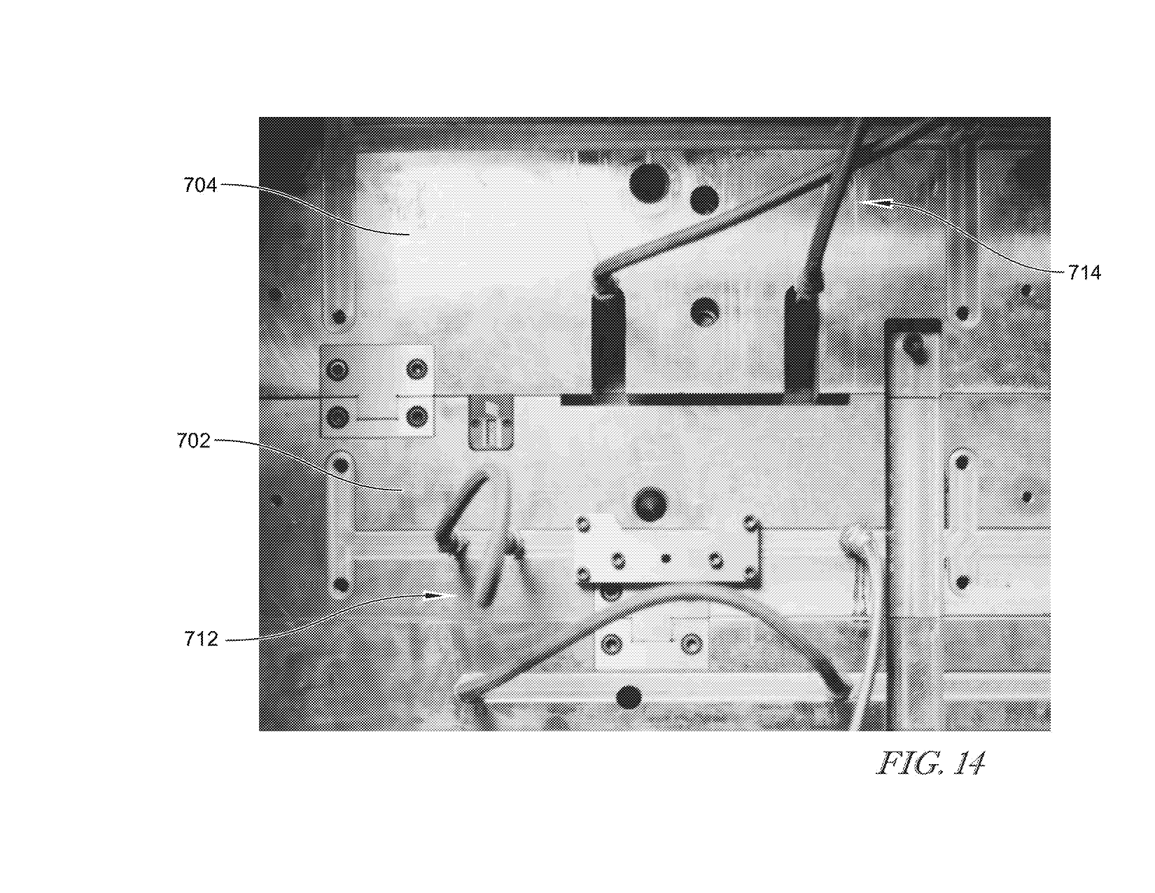

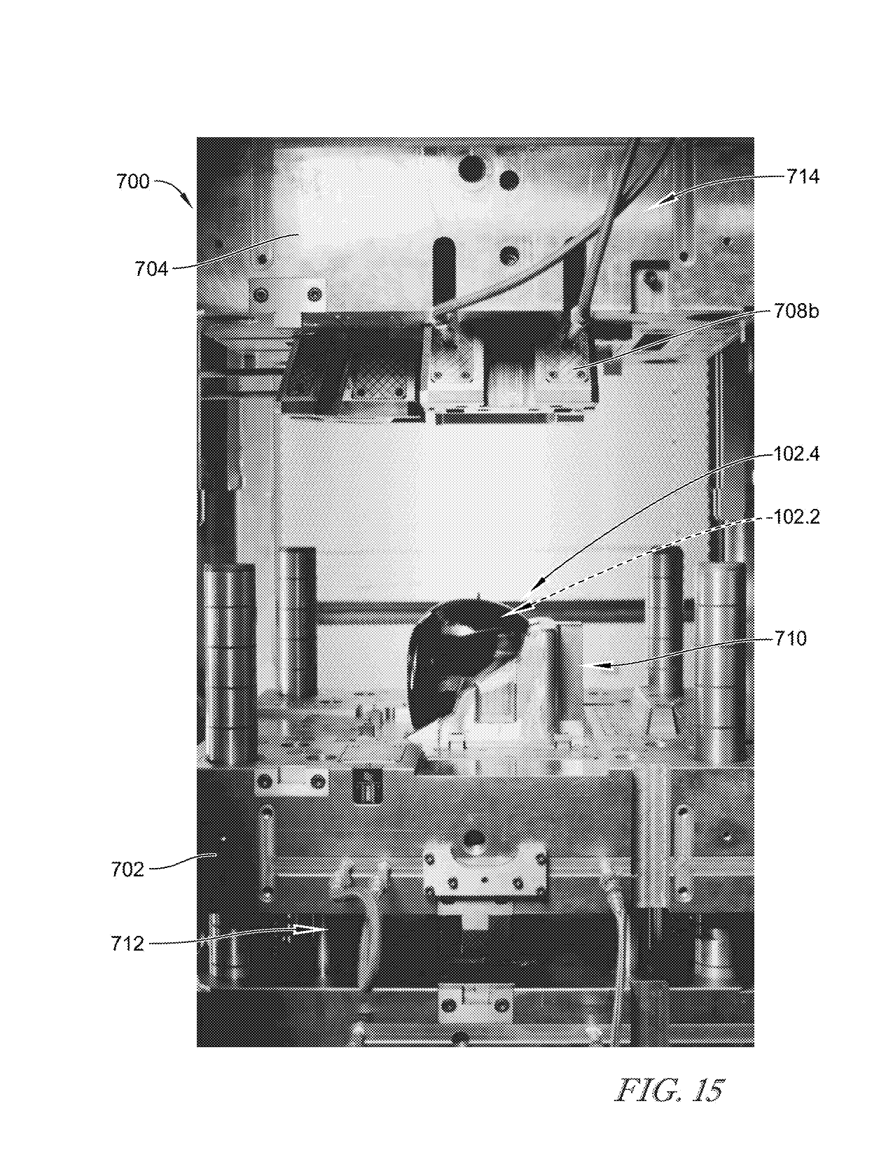

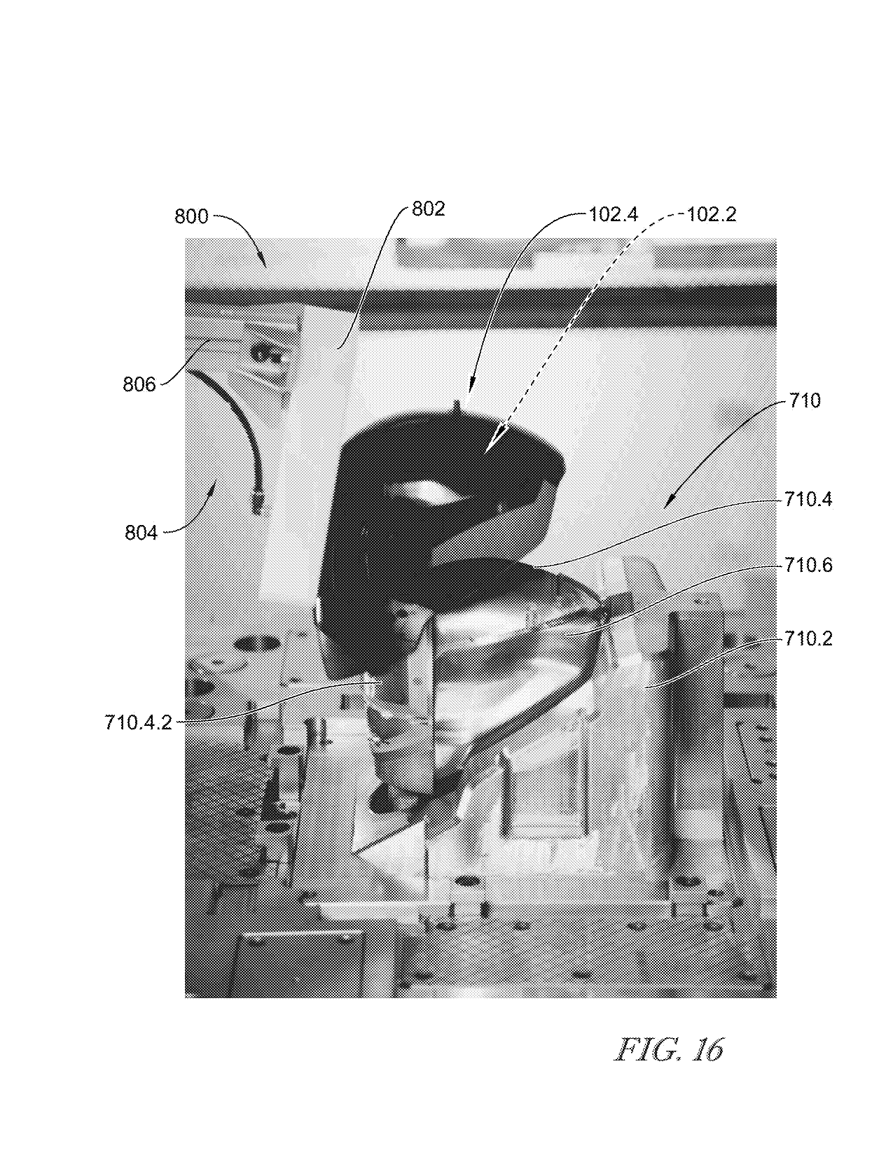

Referring to FIGS. 12-16, the shell 102.2 of the humanoid robot's head is manufactured using a high-precision injection molding process (S102) via an injection mold machine 700 to ensure structural integrity, dimensional accuracy, and scalability. The injection mold machine 700 may include a fixed platen 702, a moving platen 704, one or more tie bars 706 protruding from or extending through the fixed platen 702, a replaceable mold 708 (708a, 708b), a core 710, one or more cooling tubes 712 attached to passages of the fixed platen 702, and one or more injection tubes 714 attached to passages of the moving platen 704 and configured to inject a material into the mold 708 as discussed later. Hereinafter the one or more cooling tubes 712 and the one or more injection tubes 714 are referred to in the plurality, but the disclosure is not limited hereto. The moving platen 704 comprises a first cavity (e.g., the cavity of the replaceable mold 708a) that defines an exterior surface of the shell 102.2 of the head housing 102.

The core 710 is a metallic block that may include a core support 710.2, a shell molding portion 710.4, and a shield molding portion 710.6. The core support 710.2 is configured to support the shell molding portion 710.4 and the shield molding portion 710.6. The core support 710.2 provides a base portion under the chin sections of the shell molding portion 710.4 and the shield molding portion 710.6 and extends rearward and vertically to a rear of the shell molding portion 710.4 and the shield molding portion 710.6 to provide support to the rear of the shell molding portion 710.4 and the shield molding portion 710.6. The core support 710.2 is spaced from the shell molding portion 710.4 and the shield molding portion 710.6 so that the shell 102.2 and the shield 102.4 may be removed from the core 710 after they are manufactured as described in more detail below. The core 710 is mounted to the fixed platen 702 of the injection mold machine 700, and the core 710 remains in place on the fixed platen 702 while the mold 708 on the moving platen 704 is swapped between the shell mold 708a and the shield mold 708b.

The shell molding portion 710.4 and the shield molding portion 710.6 together have a shape that corresponds to the shape of the humanoid robot's head. The shell molding portion 710.4, which constitutes a first portion of the core 710 onto which the shell 102.2 is molded, forms the interior shape of the electronics mount 102.2.2 and its components including, but not limited to, the front display opening 102.2.2.6.2.2. The shell molding portion 710.4 includes a top section of the head and a face section of the robot and does not include the side sections of the robot's head. The face portion of the shell molding portion 710.4 may include a protrusion 710.4.2, and injection molding the shell 102.2 comprises molding the shell 102.2 around the protrusion 710.4.2 to form the at least one display opening, such as the front display opening 102.2.2.6.2.2. The shield molding portion 710.6, which constitutes a second portion of the core 710 onto which the shield 102.4 is overmolded, includes the top section of the head, the face section of the robot, and the side sections of the robot's head. The second portion of the core 710 (i.e., the shield molding portion 710.6) partially defines the interior surface of the shield 102.4 in regions where the shield 102.4 does not overlie the shell 102.2. The shell molding portion 710.4 and the shield molding portion 710.6 may for a single core or may be separate cores that are attachable to each other to form the core 710.

The replaceable mold 708a for the shell 102.2 includes a cavity that is shaped to form the external shape of the electronics mount 102.2.2 when material is injected into the mold. The cavity of the mold 708a defines the exterior surface of the shell 102.2, and the shell molding portion 710.4 (i.e., the first portion of the core 710) defines the interior surface of the shell 102.2, such that the shell 102.2 is formed in the space between the cavity and the first portion of the core 710. When molding the shell 102.2, the mold 708a for the shell 102.2 is first cleaned to remove any contaminants that may affect material flow or final part quality. Cleaning methods can include ultrasonic cleaning, solvent-based degreasing, or plasma treatment for improved material adhesion. A mold release agent is applied to aid in the easy removal of the part after formation, ensuring a smooth ejection process without defects. Once prepared, the moving platen 704 and the mold 708a are securely closed against the fixed platen 702 and heated to a controlled operating temperature ranging between 80-120°C to facilitate uniform material flow of material through the injection tubes 714 and controlled cooling via the cooling tubes 712. Temperature control systems, such as conformal cooling channels or heat exchangers, may be integrated into the mold 708a to optimize cycle time and reduce internal stresses. In some cases, high thermal conductivity mold alloys or graphite-based coatings may be applied to improve heat dissipation and further enhance cycle efficiency.

Polycarbonate resin pellets, optionally combined with colorant additives or reinforcing fillers such as glass fibers, carbon nanotubes, or aramid fibers, are introduced into an injection unit (not shown), where they are heated to a molten state at 280-320°C. The first material (e.g., polycarbonate resin) is opaque after molding, and the opacity of the shell 102.2 serves to conceal the wiring, circuit boards, and other internal electronic components from external view. The molten first material is then injected into the mold 708a for the shell 102.2 via the injection tubes 714 attached to the moving platen 704, to form the shape and geometries of the shell 102.2 between the cavity in the mold 708a and the shell molding portion 710.4. The molten material is injected into the mold 708a under high pressure (70-140 MPa) to ensure the formation of intricate geometries, structural ribs, and attachment features. The moving platen 704 and the mold 708a remain closed against the fixed platen 702 while the shell 102.2 cools and solidifies onto the core 710 over a period of 30-60 seconds, allowing for stress relief and dimensional stability. The cooling of the shell 102.2 may occur from the cooling tubes 712 supplying cooled air or liquid to or along the core 710.

To further optimize the cooling process, vacuum-assisted molding, gas-assisted injection molding, or rapid heat cycle molding (RHCM) can be employed, reducing cycle time, improving surface finish, and preventing shrinkage. These techniques may be used in combination or in isolation depending on the geometry of the shell 102.2, the type of first material being used, and the production volume targets. The selection of cooling strategy may also be informed by computational simulation tools that predict thermal gradients and residual stresses within the molded shell 102.2.

Once sufficiently solidified, the moving platen 704 and the mold 708a are separated from the fixed platen 702 while the shell 102.2 remains on the core 710. The shell 102.2 remains disposed on the core 710 after the moving platen 704 is separated from the fixed platen 702, so that the shell 102.2 can serve as the substrate for the subsequent overmolding of the shield 102.4. The shell 102.2 may be manipulated to remove or trim excess material or flash, and the shell 102.2 may undergo a thorough quality inspection using coordinate measuring machines (CMMs), optical scanning, X-ray analysis, or laser profilometry for detecting internal voids, surface anomalies, or structural weaknesses.

The shell 102.2 may be made from polycarbonate resin because of its high impact resistance, structural durability, and thermal stability. Alternative thermoplastics such as Trivex, high-impact polystyrene (HIPS), liquid crystal polymer (LCP), any other material that is disclosed herein or incorporated by reference herein, or any combination thereof, may also be used depending on the specific application. In some embodiments, multi-material injection molding can be utilized to incorporate elastomeric inserts for vibration damping, thermally conductive polymers for improved heat dissipation, or conductive polymer layers to enable electromagnetic interference (EMI) shielding. Additionally, surface texturing can be applied within the mold using laser-etched mold cavities or nanoimprint lithography, allowing for microstructural modifications to enhance grip, reduce glare, improve wear resistance, or create functional surface properties such as hydrophobicity or self-cleaning behavior. In alternative embodiments, overmolded hybrid materials, such as polymer-metal composites, may be employed to create lightweight but structurally reinforced components.

The injection molding process for the shell 102.2 may be further refined and optimized through advanced mold design methodologies and precision material handling systems. To substantially enhance structural integrity and minimize cycle times, conformal cooling channels are strategically integrated into the mold design. These conformal channels precisely trace the contours and intricacies of the part geometry, ensuring uniform, efficient heat transfer during the cooling phase, reducing thermal gradients and residual stress concentrations. Advanced fiber reinforcement strategies may enhance the mechanical properties of molded components. Short glass or carbon fibers are meticulously compounded with polycarbonate resin or alternative high-performance thermoplastics, forming a robust fiber-reinforced polymer (FRP) composite. Fiber orientation is precisely controlled during the injection molding process through specialized gate designs and computational flow analysis software, optimizing directional mechanical properties within the final molded structures. Additionally, hybrid fiber systems combining short and continuous fibers can be employed to deliver targeted structural reinforcement in various stress regions.

The mold design incorporates conformal cooling channels that precisely follow the part's geometry, enabling uniform and efficient heat transfer during the cooling phase. These conformal channels are fabricated through additive manufacturing techniques such as laser powder bed fusion (LPBF) or selective laser melting (SLM), which facilitate the creation of intricate internal channel geometries that conventional methods cannot achieve. Predictive simulation tools, such as Autodesk Moldflow and Moldex3D, are extensively utilized to model parameters, including shrinkage behavior, thermal gradients, cooling rates, and fiber orientation. These tools enable iterative mold design improvements, reducing the number of physical prototypes and accelerating development timelines.

Advanced surface treatment processes, including in-mold decoration (IMD) and in-mold labeling (IML), integrate graphics, texturing, and protective films into the molding process, enhancing durability, wear resistance, and aesthetic quality. Furthermore, biomimetic surface texturing techniques inspired by natural microstructures, such as lotus leaf surfaces for self-cleaning or shark skin textures for drag reduction, are incorporated into mold surfaces, imparting functional benefits to molded parts. Mechanical interlocking designs may be incorporated onto the outer surface of the shell 102.2 to which the shield is overmolded thereonto. The interlocking designs may include through-holes, undercuts, dovetail grooves, and textured surfaces to enhance adhesion between the shell 102.2 and the shield 102.4, such that when the shield material is injected during the overmolding process, the second material flows into and around these interlocking features to create a strong mechanical bond between the shell 102.2 and the shield 102.4. Production efficiency is enhanced through multi-cavity mold designs, facilitating simultaneous production of multiple components within each injection cycle. Computationally optimized cavity layouts ensure balanced material flow, consistent thermal management, and uniform component quality across all cavities. Additionally, modular mold designs featuring interchangeable inserts or cores allow rapid adjustments to part geometries or surface features without extensive mold reconfiguration.

Post-molding operations are streamlined using fully automated robotic handling and trimming systems integrated with the injection molding machines, establishing an automated production cell that minimizes manual intervention and maximizes throughput efficiency. Robotic trimming stations utilize high-precision CNC or laser trimming methods for accurate, repeatable finishing. Additional refinements include adaptive rheological optimization techniques, micro-cellular foaming methods like MuCell technology for weight reduction and enhanced dimensional stability, hybrid molding strategies combining multiple materials or additive manufacturing inserts, and electromagnetic field-assisted fiber alignment to enhance targeted structural properties. Localized reinforcement injection systems selectively introduce high-strength fibers or nanoparticles into various regions, further customizing mechanical performance.

Advanced adaptive process control systems employing real-time sensors and machine learning algorithms continuously monitor and adjust injection parameters, such as temperature, pressure, and flow rate, to adaptively optimize part quality. Embedded sensors, including pressure transducers and thermocouples within mold cavities, provide immediate feedback for precise process adjustments, facilitating predictive and adaptive quality control. Energy efficiency improvements include integrating regenerative braking systems on injection units, capturing kinetic energy during deceleration phases for reuse, and waste heat recovery systems to preheat materials or maintain consistent mold temperatures, reducing overall energy consumption. These process control systems may also generate production data logs that enable traceability of each manufactured shell 102.2 throughout the production process.

Once the shell 102.2 has been manufactured to a finished shell product, the mold 708a may be swapped with another mold 708b to be used for manufacturing a different component of the head housing (e.g., mold 708b for overmolding the shield 102.4). In this configuration, the first cavity (i.e., the cavity of mold 708a that defines the exterior surface of the shell 102.2) is replaced with a second cavity (i.e., the cavity of mold 708b that defines the exterior surface of the shield 102.4), and the second cavity has a different shape than the first cavity because it is shaped to form the shield 102.4 rather than the shell 102.2. Alternatively, an entirely different moving platen 704 having mold 708b attached thereon may be used for manufacturing a different component of the head housing (e.g., mold 708b for overmolding the shield 102.4). Another alternative for manufacturing a different component of the head housing (e.g., mold 708b for overmolding the shield 102.4) once the finished shell product 102.2 has been produced is to use the same moving platen 704 and mold 708 that was used for manufacturing the shell 102.2 but swapping an interior piece of the mold 708 with another interior piece in order to mold the another component (e.g., shield 102.4).

Referring to FIGS. 12-16, once the shell 102.2 of the humanoid robot is fabricated, an overmolding process is employed to form and integrate the shield 102.4 as a secondary component. Overmolding is an advanced injection molding technique where a secondary plastic material (the overmold, e.g., the shield 102.4) is injected directly over, under, or through a primary rigid plastic base (the substrate, e.g., the shell 102.2). Instead of manufacturing two discrete pieces and joining them post-production, overmolding fuses two plastics during the molding cycle itself, yielding a single unified part —referred to herein as a unitary head housing structure—that combines the structural benefits of the rigid base with the functional, aesthetic, or tactile benefits of the secondary material. Alternatively, the head housing 102 may be manufactured using a two-shot molding process in which a single mold for both the shell 102.2 and the shield 102.4 is used while the material is injected into the mold in one continuous cycle via a rotary platen. In such a two-shot molding process, the moving platen 704 rotates the shell 102.2 from the first cavity position to the second cavity position without removing the shell 102.2 from the core 710.

The overmolding process ensures a strong bond between the shield 102.4 and the shell 102.2 while maintaining optical clarity and mechanical resilience. First, the replaceable mold 708a for the shell 102.2 is swapped for a mold 708b for the shield 102.4, which includes a second cavity that is shaped to form the external shape of the shield 102.4 when material is injected into the mold. The second cavity of the mold 708b defines the exterior surface of the shield 102.4, while the second portion of the core 710 (i.e., the shield molding portion 710.6) partially defines the interior surface of the shield 102.4 in regions where the shield 102.4 does not overlie the shell 102.2. The injection tubes 714 are cleaned to ensure that there is no contamination between the materials used for the shell 102.2 and the shield 102.4. Then, while the shell 102.2, which was previously molded in S102 described above, is disposed on the core 710, the moving platen 704 and the mold 708b for the shield 102.4 are securely closed against the fixed platen 702 such that the core 710 and the shell 102.2 fit within the second cavity (S104). The mold 708b is pre-heated to a temperature range of 40-100°C to optimize adhesion between the injected shield material and the shell 102.2 while also not substantially re-melting the material of the shell 102.2. In some embodiments, pre-heating the shell 102.2 or applying a plasma treatment may be used to enhance molecular bonding between the base and overmolded layers. Additional adhesion-enhancing methods may include chemical priming of the shell 102.2 using adhesion promoters or the application of UV-activated bonding agents that create covalent bonds between the shell 102.2 and shield materials.

Acrylic resin pellets, optionally combined with UV stabilizers, anti-scratch agents, and optical additives, are melted and injected into the second cavity of the mold 708b for the shield 102.4 via the injection tubes 714 attached to the moving platen 704 at a controlled temperature of 200-300°C. The second material (e.g., acrylic resin) is transparent or semi-transparent after molding, which permits the displays 108.4.2, 108.4.4, 108.4.6 positioned behind the shield 102.4 to be visible through the shield 102.4. The injection speed profile may be multi-staged: slow initially to vent trapped air, then faster for complete cavity filling. Alternatively, the injection speed may be constant. The injection speed may depend on the materials being used. The molten acrylic is injected into the mold 708b under 50-100 MPa of pressure to form the shield 102.4 onto the shell 102.2 and the shield molding portion 710.6, ensuring full material encapsulation and secure attachment to the shell 102.2 (S106). The second material bonds with the exterior surface of the shell 102.2 to form the unitary head housing structure. All edges of the shell 102.2 may be positioned within the shield 102.4.

The space between the second cavity of the mold 708b for the shield 102.4 and the shield molding portion 710.6 of the core 710 allows for forming the shield 102.4 and all of its components with a precise geometry, including but not limited to, the lower edge 102.4.2 and exterior surface 102.4.8. In certain implementations, sequential or multi-shot overmolding may be employed, allowing for the deposition of multiple material layers in a single cycle to create a shield 102.4 with varying optical and mechanical properties. Advanced process variations, such as insert molding, may be used to embed one or more functional elements within the shield 102.4 for additional functionality. Such functional elements may include transparent conductive films, reinforcement grids, antenna structures, or microelectronic components, each of which may be placed into the second cavity of the mold 708b prior to injection of the second material so that the functional elements become embedded within the shield 102.4 during the overmolding process. The embedded functional elements may include transparent conductive pathways formed from materials such as graphene or indium tin oxide (ITO), and these transparent conductive pathways may enable at least one of a touch-sensitive interface, a defogging capability, or a transparent antenna for wireless communication. The mold 708b remains closed while the acrylic cools and bonds with the polycarbonate base over a period of 45-90 seconds. Gas-assist and water-assist injection molding techniques may also be employed to create complex internal structures, allowing for the integration of cooling channels, weight reduction features, or embedded microelectronics.

The molding process can be refined by utilizing variothermal molding, where the mold temperature is dynamically controlled throughout the cycle. This method enhances flow characteristics, reduces residual stresses, and improves the surface finish by minimizing weld lines and optical distortions. Additionally, microcellular foam injection molding (MuCell) can be utilized to create a lightweight, high-strength shield 102.4 by introducing inert gas into the molten polymer before injection, resulting in a uniform microcellular structure that enhances impact resistance while reducing material consumption. Compression overmolding, which combines injection molding with compression molding, can further enhance uniform material distribution, minimize internal stresses, and improve the structural integrity of the final shield 102.4. In embodiments where compression overmolding is used, the moving platen 704 may apply additional compression force after the second material is injected into the second cavity.

The selection of shield materials can be adjusted to suit different application needs. In addition to acrylic, polycarbonate-based composites can be used for added impact resistance. In certain embodiments, thermoplastic polyurethane (TPU) or cyclic olefin copolymers (COC) may be incorporated to provide flexibility and enhanced optical clarity. Additional material choices may include siloxane-based hybrid polymers for increased thermal and chemical resistance or high-refractive-index polymers for optimized optical performance in augmented reality (AR) applications. Furthermore, multi-layer laminated shields 102.4 incorporating photochromic or electrochromic layers can be used to enable adaptive light transmission properties, further expanding the functional capabilities of the humanoid robot head. Additionally, advanced bonding agents or nanostructured adhesion promoters may be introduced at the interface between the shell 102.2 and the shield 102.4, improving durability, preventing delamination, and enhancing resistance to environmental exposure, such as UV degradation or thermal cycling. In some cases, self-healing polymer coatings can be applied post-molding to enhance the longevity of the shield surface, reducing the impact of minor scratches and abrasions over time.

To further enhance functionality, multi-material co-injection molding can be used to simultaneously inject two or more compatible polymers, creating a shield 102.4 with a gradient of properties such as a soft, impact-absorbing inner layer transitioning to a hard, scratch-resistant outer layer. The bond strength between the shield 102.4 and the shell 102.2 structure can also be improved using interpenetrating polymer networks (IPNs), which allow for molecular-level entanglement of the overmolded material with the base polymer, reducing the risk of delamination. These IPNs may be formed by selecting a second material that has a chemical affinity for the first material of the shell 102.2, such that polymer chains of the second material diffuse into the surface of the shell 102.2 during the overmolding process. The degree of interpenetration may be controlled by adjusting the pre-heat temperature of the mold 708b and the injection temperature of the second material.

The overmolding process can also incorporate advanced optical elements, such as micro-lens arrays or waveguide structures, which can be molded into the shield 102.4 using precision-engineered mold inserts. These elements can enhance light transmission, reduce glare, or provide embedded display functionalities. Additionally, plasma-enhanced chemical vapor deposition (PECVD) can be applied immediately post-molding to create ultra-thin, conformal barrier coatings that improve chemical resistance, moisture ingress protection, and abrasion resistance without compromising optical clarity.

The shield's 102.4 mechanical and thermal properties can be further enhanced by embedding phase-change material (PCM) microcapsules within the polymer matrix, providing passive thermal regulation. These PCMs absorb excess heat during high-intensity operations and release it when temperatures drop, ensuring stable performance in varying environmental conditions. Additionally, incorporating self-healing mechanisms, such as microencapsulated healing agents or reversible cross-linking polymers, can extend the lifespan of the shield 102.4 by allowing minor scratches or cracks to autonomously repair over time. The PCM microcapsules may be introduced into the acrylic resin pellets prior to melting, or they may be separately injected into the mold 708b at a controlled stage of the overmolding process.

Another refinement includes the integration of transparent conductive pathways using materials such as graphene or indium tin oxide (ITO). These pathways enable additional functionalities such as integrated touch-sensitive interfaces, defogging capabilities, or transparent antenna structures for improved communication. Further improvements in manufacturing precision can be achieved through the use of machine learning algorithms that optimize molding parameters in real time, ensuring defect-free production and enhanced quality control. In some embodiments, the transparent conductive pathways may be deposited onto the shell 102.2 prior to overmolding, such that the second material encapsulates and protects the conductive pathways during the overmolding step.

Once the overmolding process is complete, the moving platen 704 and the mold 708b are separated from the fixed platen 702 to release the unitary head housing structure comprising the shell 102.2 and the shield 102.4 bonded together. By integrating these cutting-edge technologies, the humanoid robot shield 102.4 transitions from a protective covering to an intelligent, adaptive interface capable of advanced sensing, computing, and environmental interaction. These innovations enhance the robot's cognitive and sensory abilities, enabling unparalleled adaptability across diverse applications, from extreme environments to high-precision tasks with real-time responsiveness and advanced perception. The unitary head housing structure formed by the overmolding process provides a monolithic bond between the first material and the second material that is stronger and more uniform than bonds achieved through post-production adhesives, ultrasonic welding, or mechanical fasteners.

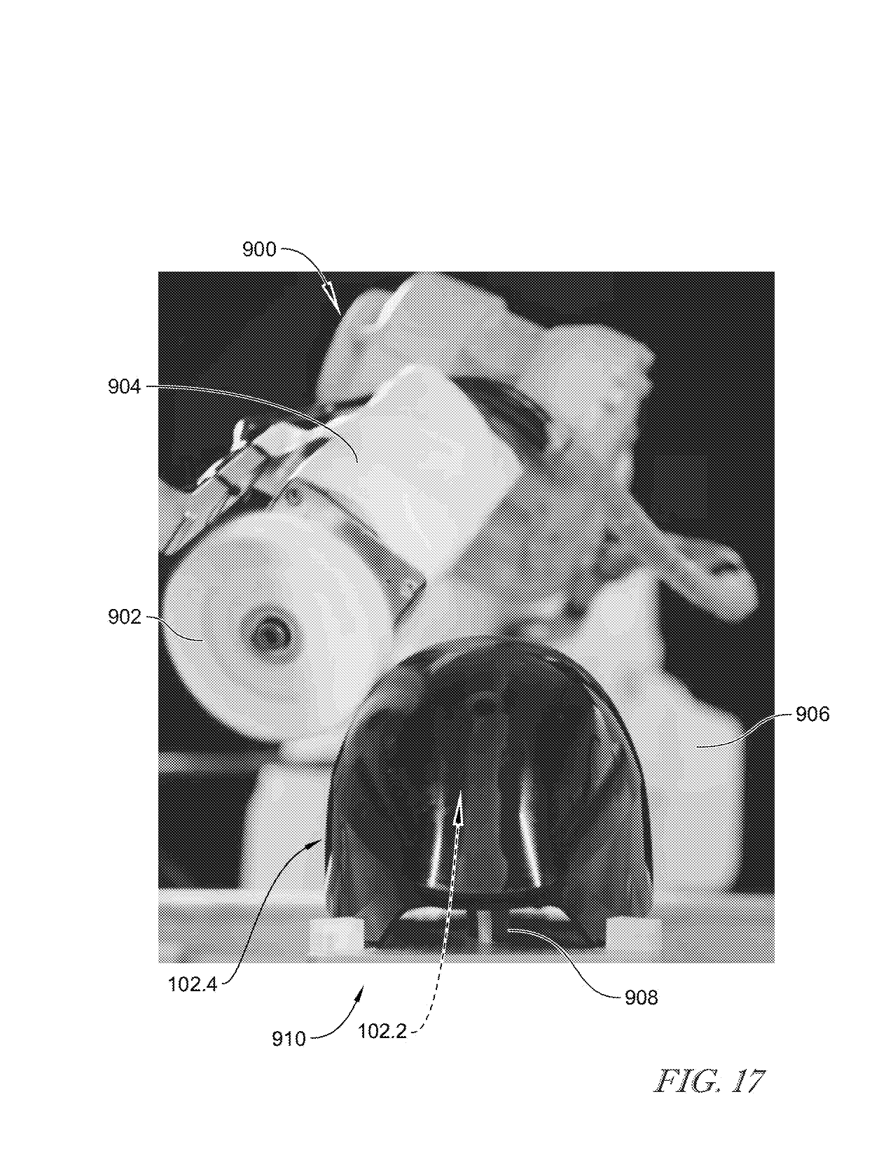

Referring to FIGS. 12 and 16-17, after the shield 102.4 is overmolded onto the shell 102.2 and the shield 102.4 is ready to be polished, the moving platen 704 and the mold 708b are moved away from the fixed platen 702 to allow for the shield 102.4 to be manipulated and/or for the shield 102.4 and the shell 102.2 to be moved together to a polishing station so that the shield 102.4 can be polished in a shield polishing process (S108). The shield 102.4 and the shell 102.2 may be moved together via a moving apparatus 800. The moving apparatus 800 includes a motor, a contact portion 802 comprising one or more vacuum holes configured to contact a portion of the head portion (e.g., the shield 102.4), a vacuum 804 connected to the contact portion 802, and an arm 806 also connected to the contact portion 802. The arm 806 may be a multi-axis robotic arm configured to move the unitary head housing structure from the injection mold machine 700 to the polishing station. To move the shield 102.4 and the shell 102.2 together to the polishing station, the contact portion 802 may contact the exterior surface 102.4.8 of the shield 102.4 while the vacuum 804 operates to suction the shield 102.4 to the contact portion 802. Once the shield 102.4 is sufficiently suctioned to the contact portion 802, the arm 806 may move the shield 102.4 and the shell 102.2 together to the polishing station illustrated in FIG. 17 for the shield polishing process via a polishing apparatus 900 (S110). To facilitate the release of the shield 102.4 and the shell 102.2 together from the shell molding portion 710.4 and the shield molding portion 710.6, the shell molding portion 710.4 and the shield molding portion 710.6 may be cooled so the shield 102.4 and the shell 102.2 do not stick to the shell molding portion 710.4 and the shield molding portion 710.6 when the arm 806 moves the shield 102.4 together with the shell 102.2 to the polishing station. Additionally, or alternatively, the shell molding portion 710.4 and the shield molding portion 710.6 may include a plurality of venting holes, that may be opened and closed, to facilitate the release of the shield 102.4 and the shell 102.2 together from the shell molding portion 710.4 and the shield molding portion 710.6. Moreover, additionally or alternatively, air may be supplied through the space between the core support 710.2 and the shell molding portion 710.4 and the shield molding portion 710.6 to additionally facilitate the release of the shield 102.4 and the shell 102.2 together from the shell molding portion 710.4 and the shield molding portion 710.6.

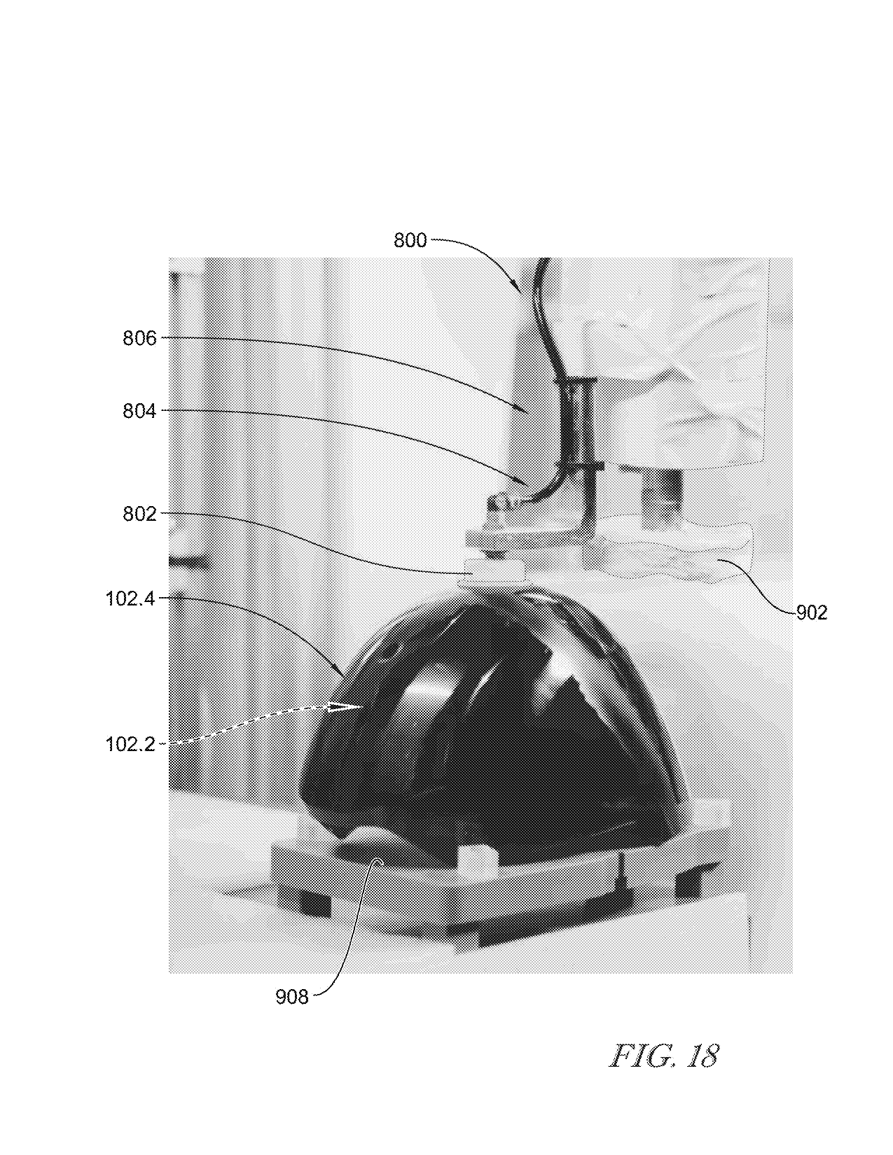

The moving apparatus 800 may also function as the polishing apparatus 900 such that the contact portion 802 may be replaced by a polishing tool 902 or the moving apparatus may further include the polishing tool 902, as illustrated in FIG. 18. Alternatively, the polishing apparatus 900 may be a separate apparatus from the moving apparatus 800. The polishing apparatus 900 includes the polishing tool 902, an arm 904, and a motor 906. In embodiments where the moving apparatus 800 and the polishing apparatus 900 are the same apparatus, a single robotic arm performs both the transport and polishing functions by swapping end effectors.

As illustrated in FIG. 17, the shield polishing process utilizes robotic systems to achieve a high-quality optical finish on the overmolded shield 102.4. This automated approach ensures consistency and precision across large production volumes and minimizes defects associated with manual polishing techniques. The polishing process begins with the unitary head housing structure being securely held in a custom-designed fixture 908 that provides unrestricted access to all surfaces of the shield 102.4 for treatment. The fixture 908 may incorporate vacuum suction, magnetic retention, or mechanical clamping mechanisms to ensure stability without causing deformation or surface damage. In some embodiments, the fixture 908 is mounted on a rotational stage 910 to facilitate multi-angle access during polishing operations.

The arm 904 is a multi-axis robotic arm equipped with a specialized end effector to manipulate polishing tools 902. The end effector may include force feedback sensors to maintain consistent pressure and compensate for variations in shield 102.4 geometry. Additionally, compliance control mechanisms, such as pneumatically actuated or actively controlled tool mounts, may be integrated to accommodate slight surface variations. In alternative configurations, dual robotic arms may operate in synchrony to perform simultaneous polishing on multiple surfaces, increasing throughput and reducing cycle times.

The polishing tool 902 may be a polishing pad, and the arm 904 manipulates the polishing tool 902 across the exterior surface 102.4.8 of the shield 102.4. Polishing compounds are dispensed precisely onto the pads using automated dosing systems. In certain implementations, the polishing pads are continuously cleaned and conditioned via integrated pad maintenance stations that employ ultrasonic cleaning, solvent rinsing, or mechanical scrubbing to maintain consistent performance. Environmental controls such as temperature and humidity regulation may be integrated into the polishing chamber to enhance process stability and prevent contamination. Dust and debris generated during polishing are managed using high-efficiency particulate air (HEPA) filtration and localized extraction systems to maintain a clean working environment.

Following the final polishing stage, the shield 102.4 undergoes an automated cleaning process to remove residual polishing compounds. This may involve immersion in ultrasonic cleaning baths, high-pressure air or liquid rinsing, or the application of specialized solvent-based cleaning agents designed to preserve the newly polished optical surface without introducing artifacts. Quality control measures are implemented using high-resolution optical inspection systems equipped with machine learning-based defect detection algorithms. These systems analyze images to identify surface inconsistencies, scratches, or other imperfections. In some configurations, profilometry or atomic force microscopy (AFM) techniques may be employed to quantitatively assess surface roughness and ensure compliance with stringent optical quality standards.

The entire polishing process is governed by an integrated control system that coordinates robotic arm movements, material dispensing, and process monitoring. This system utilizes closed-loop feedback control to adaptively refine polishing parameters based on real-time sensor data. In some embodiments, process analytics and predictive maintenance algorithms are employed to detect equipment wear, optimize consumable usage, and enhance overall efficiency. This automated shield polishing system is designed to be scalable for high-volume manufacturing while maintaining the flexibility to accommodate variations in shield geometry, material composition, and surface treatment. By leveraging robotic automation, real-time process monitoring, and advanced quality control methodologies, the system ensures consistent, defect-free production of optical-grade shields across a range of applications.

Referring to FIG. 12, once the shield 102.4 is polished, the display housing sections 102.2.2.14, 102.2.2.16 and the support frame 102.2.4 may be manufactured (S112). The display housing sections 102.2.2.14, 102.2.2.16 and the support frame 102.2.4 may be manufactured using an injection molding process similar to that used for the shell 102.2. The molds 708 for the display housing sections 102.2.2.14, 102.2.2.16 and the support frame 102.2.4 are designed to incorporate specific features that facilitate integration with other head components and allow for natural movement. The injection molding processes for the display housing sections 102.2.2.14, 102.2.2.16 and the support frame 102.2.4 utilize a high-performance thermoplastic polymer, such as glass-fiber reinforced polyamide or polycarbonate, to ensure structural integrity and impact resistance. The display housing sections 102.2.2.14, 102.2.2.16 and the support frame 102.2.4 may be manufactured during a single manufacturing process or separate manufacturing processes. Hereinafter, the manufacturing process for the display housing sections 102.2.2.14, 102.2.2.16 and the support frame 102.2.4 is described in which the display housing sections 102.2.2.14, 102.2.2.16 and the support frame 102.2.4 are manufactured separately.

Prior to injection, the mold 708 is thoroughly cleaned and treated with a release agent to facilitate easy part removal. The mold 708 is then heated to an optimal temperature range of 80-120°C to ensure uniform material flow and controlled cooling. The polymer resin, potentially combined with additives for enhanced mechanical properties or color matching, is melted in the injection unit at temperatures ranging from 260-300°C. The molten material is injected into the mold 708 under high pressure (70-120 MPa) to form the intricate geometries and attachment features of the display housing sections 102.2.2.14, 102.2.2.16 or the support frame 102.2.4.

The mold 708 remains closed for a cooling period of 30-60 seconds, allowing the display housing sections 102.2.2.14, 102.2.2.16 or the support frame 102.2.4 to solidify and achieve dimensional stability. Once cooled, the display housing sections 102.2.2.14, 102.2.2.16 or the support frame 102.2.4 are ejected using a combination of mechanical ejector pins and air-assisted ejection systems to minimize the risk of deformation or surface defects. Any excess material or flash is carefully trimmed, and the display housing sections 102.2.2.14, 102.2.2.16 or the support frame 102.2.4 undergo quality inspection using coordinate measuring machines (CMMs) or optical scanning systems to verify dimensional accuracy and surface quality. Each display housing section 102.2.2.14, 102.2.2.16 includes at least one display opening configured to receive a respective side display 108.4.4, 108.4.6 of the electronics assembly 108.

After the display housing sections 102.2.2.14, 102.2.2.16 and the support frame 102.2.4 are manufactured, the head housing 102 may be assembled by attaching the display housing sections 102.2.2.14, 102.2.2.16 and the support frame 102.2.4 to the shell 102.2 together with the shield 102.4 (S114). In particular, the display housing sections 102.2.2.14, 102.2.2.16 are attached to the shell 102.2 after the moving platen 704 has been separated from the fixed platen 702 to release the unitary head housing structure formed by the shell 102.2 and the shield 102.4. Once attached to the shell 102.2, the display housing sections 102.2.2.14, 102.2.2.16 are covered by the shield 102.4, such that the shield 102.4 overlies and protects the display housing sections 102.2.2.14, 102.2.2.16 and the side displays mounted therein. The attachment of the display housing sections 102.2.2.14, 102.2.2.16 to the shell 102.2 may be achieved using mechanical fasteners, snap-fit connections, adhesive bonding, or any combination thereof.

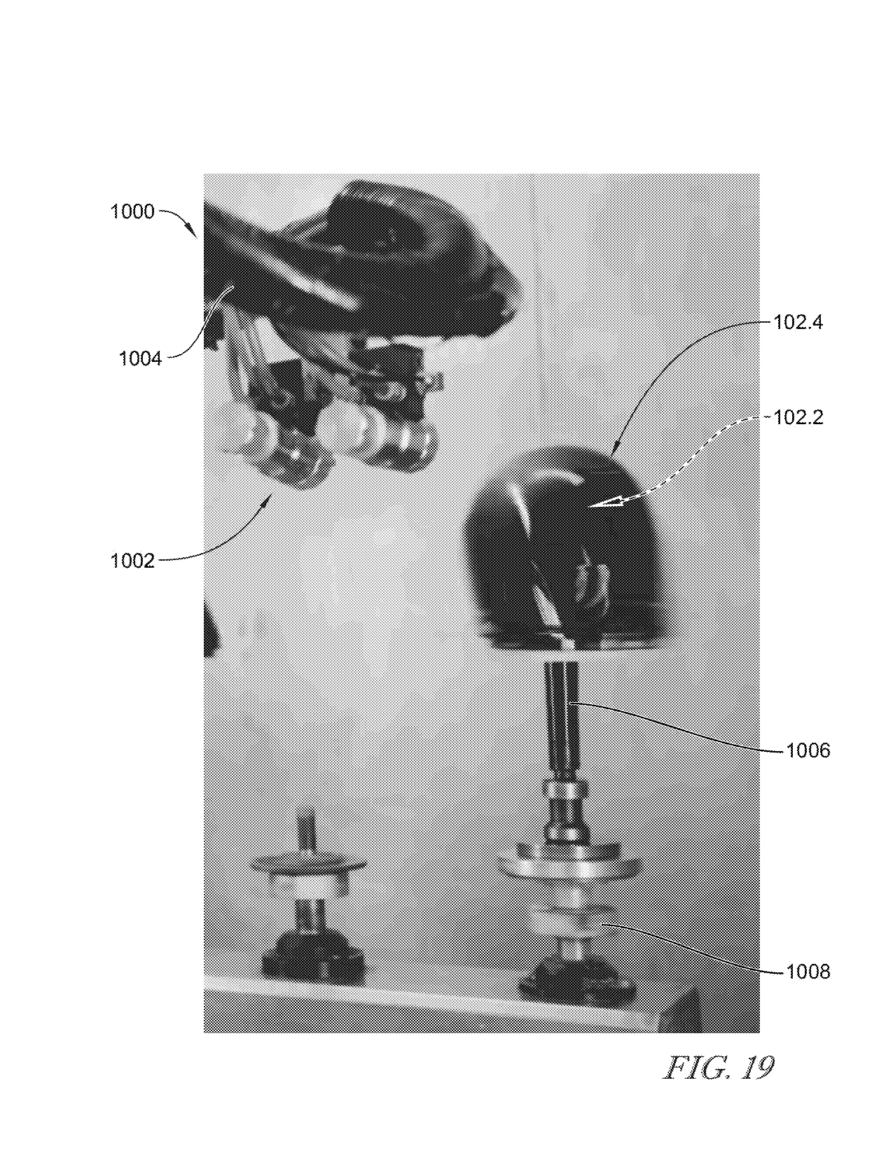

Referring to FIGS. 12 and 18-19, once the head housing 102 is assembled with the shell 102.2, the shield 102.4, the display housing sections 102.2.2.14, 102.2.2.16, and the support frame 102.2.4, the head housing 102 may be transported to a coating station for coating the external surface 102.4.8 of the shield 102.4 (S116 and S118). The head housing 102 may be transported to the coating station by the moving apparatus 800. FIG. 18 illustrates the moving apparatus 800 and the polishing apparatus 900 as being a single apparatus that includes a contact portion 802 and a polishing tool 902. Referring to FIG. 19, the coating station may include a coating apparatus 1000 and a rotary stand 1006 attached to a motor 1008 configured to rotate the stand 1006. The coating apparatus 1000 includes one or more sprayers 1002 to coat the head housing 102 and an arm 1004 for moving the sprayers 1002.

The coating process may enhance the performance and longevity of the shield 102.4, by applying a variety of optical coatings to the shield 102.4 post-overmolding. These coatings can be deposited using vacuum deposition techniques, dip coating, spray coating, or plasma-enhanced chemical vapor deposition (PECVD) to ensure uniform surface application and optimal adhesion. In some cases, coatings may be pre-integrated into the acrylic resin before injection molding to achieve consistent performance across the entire external surface 102.4.8 of the shield 102.4. The coating of the exterior surface 102.4.8 of the shield 102.4 may comprise spraying the exterior surface 102.4.8 using the one or more sprayers 1002 while rotating the unitary head housing structure on the rotary stand 1006, so that the one or more sprayers 1002 can reach all accessible surfaces of the shield 102.4.

### COMMON OPTICAL COATINGS INCLUDE

Anti-Reflective (AR) Coating: Applied to the inner and/or outer surfaces to minimize glare and improve visibility of internal displays. This is achieved through the deposition of thin-film dielectric layers, which reduce surface reflectivity.

Scratch-Resistant Hard Coating: Enhances surface durability, protecting against abrasions and external wear. This coating is often applied via dip coating followed by UV or thermal curing to form a robust protective layer.

Hydrophobic and Oleophobic Coatings: Provides water and oil repellency, reducing smudging and facilitating easier cleaning. These coatings, typically based on fluoropolymer compounds, create a non-stick surface that resists contamination and fingerprint accumulation.

Anti-Fog Coating: Prevents moisture condensation on the shield surface by modifying surface tension, ensuring clarity in high-humidity environments. This coating is commonly applied via spray deposition followed by thermal curing.

UV-Blocking Coating: Reduces ultraviolet light penetration, protecting internal components and extending the lifespan of the shield material. UV-resistant polymers can be incorporated into the acrylic before molding, or a post-mold UV coating can be applied using vacuum deposition methods.

The selection of coatings is optimized based on manufacturing efficiency, durability, and optical performance. By integrating these coatings, the shield 102.4 can maintain high clarity and remain resistant to environmental factors such as dust, scratches, and moisture accumulation. The method of application is determined based on adhesion strength, cost-effectiveness, and operational durability. Examples of such optical coatings include anti-reflection coatings, mirror coatings, hard coatings, anti-static coatings, and anti-fog coatings, some of which are described within U.S. patent application Nos. 16/896,016, 16/698,775, 16/417,311, 16/126,983, 15/359,317, 15/515,966, and U.S. Patent Nos. 8,770,749; 9,134,547, 9,383,594; 9,575,335; 9,910,297, each of which is incorporated herein by reference. Further, the material composition, shape, number of layers, and composition of said layers of the shield 102.4 contained in one region of said shield 102.4 may be different from the material composition, shape, number of layers, and composition of the shield 102.4 contained in another region. In other words, the composition, shape, number of layers, and composition of said layers may vary across the surface of the shield 102.4.

### b. Mechanical and Electrical Architecture

The mechanical and electrical architecture may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness needed to perform such a diverse array of generalized tasks. The head housing 102, manufactured according to the overmolding process described herein, provides the mechanical and electrical architecture of the head portion 10.1 with a durable, optically transparent, and structurally unified enclosure that protects the electronics assembly 108 while permitting visual and wireless communication with the external environment.

### D.Industrial Application

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut -shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data.This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. Patent Application Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/442,030, 19/443,231, 19/443,345, 19/536,458, 19/538,967, 19/552,233, 19/387,569, 19/381,159, 19/557,667, 19/557,966, 19/557,999, 19/558,158, 19/066,122, 19/392,086, 19/180,106, 19/249,517, 19/286,240, 19/319,712, 19/323,751, 19/325,415, 19/325,486, 19/329,008, 19/337,852, 19/337,899, 19/347,690, 19/347,994, 19/351,294, 19/352,959, 19/355,393, 19/355,531, 19/355,786, 19/378,092, 19/378,308; and (iii) U.S. Design Patent Application Nos. 29/889,764, 29/928,748, 29/935,680, 29/954,572, 29/967,462, 29/993,115, and 29/998,761; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A method of manufacturing a head housing for a humanoid robot, the method comprising:
injecting a first material into a first cavity to form a shell of the head housing, wherein the first cavity defines an exterior surface of the shell, wherein the first cavity surrounds a first core that defines an interior surface of the shell, and wherein the first material of the formed shell has a first opacity;
after forming the shell, positioning the shell within a second cavity having a different shape than the first cavity, wherein the second cavity defines an exterior surface of a shield of the head housing, and wherein the second cavity surrounds a second core that partially defines an interior surface of the shield; and
injecting a second material different from the first material into the second cavity to form the shield on the shell and the second core that partially defines the interior surface of the shield, wherein the second material bonds with the exterior surface of the shell to form a unitary head housing structure, and wherein the second material of the formed shield has a second opacity that is less than the first opacity.

2. The method of claim 1, further comprising:
before injecting the first material into the first cavity, moving a moving platen of an injection molding machine against a fixed platen of the injection molding machine, wherein the moving platen comprises the first cavity, and wherein the fixed platen comprises the first core that defines the interior surface of the shell;
after injecting the first material into the first cavity:
separating the moving platen from the fixed platen;
replacing the first cavity with the second cavity; and
moving the moving platen comprising the second cavity against the fixed platen; and
after injecting the second material into the second cavity, separating the moving platen from the fixed platen to release the unitary head housing structure.

3. The method of claim 2, wherein (i) the first core that defines the interior surface of the shell and (ii) the second core that partially defines the interior surface of the shield are separate portions of a single core, and wherein the shell remains on the single core while injecting the second material into the second cavity.

4. The method of claim 1, wherein the first material comprises a first polymer, and wherein the second material comprises a second polymer.

5. The method of claim 1, wherein the shield has a surface that is curved along both a z-axis of the head housing and an x-axis of the head housing.

6. The method of claim 1, further comprising:
forming a plurality of display housing sections; and
after injecting the second material into the second cavity to form the shield on the shell, attaching the plurality of display housing sections to the shell such that the plurality of display housing sections are covered by the shield.

7. The method of claim 1, wherein injecting the second material different from the first material into the second cavity to form the shield on the shell and the second core that partially defines the interior surface of the shield comprises embedding one or more functional elements within the shield, wherein the one or more functional elements comprise at least one of a transparent conductive film, a reinforcement grid, an antenna structure, or a microelectronic component.

8. The method of claim 7, wherein the one or more functional elements comprise a transparent conductive pathway that enables at least one of a touch-sensitive interface or a transparent antenna.

9. The method of claim 1, further comprising:
after injecting the second material into the second cavity to form the shield on the shell, moving the unitary head housing structure to a polishing station using a robotic arm; and
polishing the shield at the polishing station using a polishing tool of the robotic arm.

10. The method of claim 9, wherein polishing the shield comprises securing the unitary head housing structure in a fixture of the polishing station and manipulating the polishing tool across the exterior surface of the shield.

11. The method of claim 10, further comprising:
after polishing the shield, moving the unitary head housing structure from the polishing station to a coating station comprising a rotary stand;
attaching the unitary head housing structure to the rotary stand; and
while rotating the rotary stand, applying a coating via one or more sprayers to the exterior surface of the shield, wherein the coating comprises at least one of an anti-reflective coating or a scratch-resistant hard coating.

12. The method of claim 10, wherein injecting the second material into the second cavity to form the shield on the shell comprises forming the shield on the shell such that all edges of the shell are positioned within the shield.

13. A method of manufacturing a head housing for a humanoid robot, the method comprising:
injection molding a shell of the head housing by injecting a first material into a first mold, wherein the shell is formed on a first portion of a first core and comprises at least one display opening and a first plurality of sensor openings;
after the shell is formed on the first core, replacing the first mold with a second mold; and
overmolding a shield onto the shell by injecting a second material different from the first material into the second mold, wherein the shield is formed on (i) the shell and (ii) a second core to form a unitary head housing structure, wherein the shield is configured to cover the at least one display opening, and wherein the shield comprises a second plurality of sensor openings that are aligned with the first plurality of sensor openings of the shell.

14. The method of claim 13, wherein the first core and the second core are separate portions of a single core that is mounted to a fixed platen of an injection mold machine, and wherein the first mold and the second mold are each mounted to a moving platen of the injection mold machine.

15. The method of claim 13, wherein the first core comprises a protrusion, and wherein the injection molding the shell comprises molding the shell around the protrusion to form the at least one display opening.

16. The method of claim 13, wherein the injection molding the shell comprises injecting the first material through one or more injection tubes attached to a moving platen of an injection mold machine, and wherein overmolding the shield comprises injecting the second material through the one or more injection tubes attached to the moving platen.

17. The method of claim 13, wherein the second material is transparent or semi-transparent after molding, and wherein the first material is opaque after molding.

18. The method of claim 13, wherein the shield extends from a chin region of the head housing to a parietal region of the head housing and wraps around lateral sides of the head housing to respective auricular regions.

19. The method of claim 13, wherein the shield is curved in both a vertical direction and a horizontal direction across the head housing.

20. The method of claim 13, wherein the unitary head housing structure does not cover an occipital region of a head of the humanoid robot, wherein the method further comprises:
attaching the unitary head housing structure to a support frame that comprises the occipital region of the head of the humanoid robot.
